(19) United States
(12) Patent Application Publication
(10) Pub. No.: US 2017/0180777 A1
(43) Pub. Date: Jun. 22, 2017

(54) DISPLAY APPARATUS, REMOTE CONTROL APPARATUS, AND CONTROL METHOD THEREOF

(71) Applicant: SAMSUNG ELECTRONICS CO., LTD., Suwon-si (KR)

(72) Inventors: Joon-ho PHANG, Seoul (KR); Na-young KOH, Seoul (KR); Jean-Christophe NAOUR, Seoul (KR); Kwan-min LEE, Seoul (KR)

(73) Assignee: SAMSUNG ELECTRONICS CO., LTD., Suwon-si (KR)

(21) Appl. No.: 15/378,212

(22) Filed: Dec. 14, 2016

(30) Foreign Application Priority Data
Dec. 17, 2015 (KR) 10-2015-0181124

(51) Int. Cl. H04N 21/422; H04N 21/45; H04N 21/482; H04N 21/462; H04N 21/81

(52) U.S. Cl. CPC H04N 21/42224; H04N 21/4622; H04N 21/8133; H04N 21/4821; H04N 21/42222; H04N 21/4532; H04N 21/8173

(57) ABSTRACT

A remote control apparatus which controls a display apparatus is provided. The remote control apparatus includes: a communicator configured to communicate with the display apparatus; a user interface configured to receive a first user command of touching a control surface or a second user command of pressing the control surface or releasing the pressing; and a processor configured to, in response to the first user command, control the communicator to transmit, to the display apparatus, a signal for displaying preview information on a screen of the display apparatus, and, in response to the second user command, control the communicator to transmit, to a display apparatus, a signal for executing a function related to the preview information.

### CROSS-REFERENCE TO RELATED APPLICATIONS

This application claims priority from Korean Patent Application No. 10-2015-0181124, filed on Dec. 17, 2015, in the Korean Intellectual Property Office, the disclosure of which is incorporated herein by reference in its entirety.

### BACKGROUND

Field

Apparatuses and methods consistent with exemplary embodiments broadly relate to a display apparatus, a remote control apparatus, and a control method thereof, and more particularly, to a display apparatus which can be remotely controlled, a remote control apparatus which controls a display apparatus, and a control method thereof.

Description of the Related Art

In general, a display apparatus such as a digital TV or the like provides a remote control apparatus for remotely controlling the operation of the corresponding display apparatus for the sake of user convenience. A recent display apparatus provides various kinds of contents, such as a broadcast content, a video on demand (VOD) content, a video content, a music content, an image content, or the like, and a remote control apparatus provided along with the display apparatus may perform various functions to provide such contents easily and efficiently.

A related-art remote control apparatus includes a standardized user interface structure which is formed of a channel button, a volume button, a navigation key such as an arrow mark for selecting a menu, or the like, and accordingly, there is a difficulty in performing various functions provided by the display apparatus with the remote control apparatus. For example, in order to select a desired function on a menu or search for a desired content from many sources, users should operate by alternately selecting four-direction buttons provided in the remote control apparatus many times and pressing them.

### SUMMARY

One or more exemplary embodiments may overcome the above disadvantages and other disadvantages not described above. However, it is understood that one or more exemplary embodiment are not required to overcome the disadvantages described above, and may not overcome any of the problems described above.

One or more exemplary embodiments provide an easy operation experience enabling a user to intuitively control a display apparatus using a remote control apparatus.

One or more exemplary embodiments also provide a method for rapidly and easily finding a content desired by a user from many and various contents provided through a display apparatus.

One or more exemplary embodiments also provide a method for rapidly and easily performing a function desired by a user from among various functions supported by a display apparatus.

According to an aspect of an exemplary embodiment, there is provided a remote control apparatus which controls a display apparatus, the remote control apparatus including: a communicator configured to communicate with the display apparatus; a user interface configured to receive a first user command in which a control surface is touched or a second user command in which the control surface is pressed or press released; and a processor configured to, in response to the first user command being input, control the communicator to transmit, to the display apparatus, a signal for displaying preview information on a screen of the display apparatus, and, in response to the second user command being input, control the communicator to transmit, to the display apparatus, a signal for executing a preview information related function.

The preview information related function may include at least one of a first function of displaying visual information related to the preview information on the screen of the display apparatus, a second function of outputting auditory information related to the preview information, and a third function of transmitting data related to the preview information to an external device.

In response to the control surface being allocated to a function related to an application, the preview information may be an application history list including identification information of previously executed applications, and the preview information related function may be a function of displaying an application list including identification information of applications which are executable through the display apparatus.

In addition, in response to the control surface being allocated to a function related to a broadcast channel, the preview information may be a broadcast channel history list including identification information of previously viewed broadcast channels, and the preview information related function may be a function of displaying a broadcast channel list including identification information of broadcast channels which provide broadcast contents through the display apparatus.

In addition, in response to the control surface being allocated to a function related to a content, the preview information may be a control menu including identification information of functions for controlling content which is provided through the display apparatus, and the preview information related function may be a function corresponding to identification information which is selected according to the second user command from among the identification information of the functions included in the control menu.

In addition, in response to the control surface being allocated to a function related to a source device, the preview information may be a source list including identification information of source devices which provide contents through the display apparatus, and the preview information related function may be a function of displaying content or a list of contents included in a source device corresponding to identification information which is selected according to the second user command from among the identification information included in the source list.

In addition, in response to the control surface being allocated to a function related to broadcast channel zapping, the preview information may be EPG information of a previous or next broadcast channel with respect to a currently broadcast channel, and a part or a portion of a broadcast content which is being provided in the previous or next broadcast channel, and the preview information related function may be a function of displaying broadcast content which is being reproduced in the previous or next broadcast channel.

In addition, the remote control apparatus may further include a detector configured to detect a moving direction of the remote control apparatus, and the processor may be configured to control the communicator to transmit, to the display apparatus, a signal for changing an emphasized or highlight location on the screen of the display apparatus to a different location according to the detected moving direction.

In a state in which the first user command of touching the control surface is received, the user interface may be configured to receive the second user command of continuously pressing the touched control surface.

According to yet another aspect of an exemplary embodiment, there is provided a display apparatus which is controlled by a remote control apparatus, the display apparatus including: a display configured to display a screen; a communicator configured to communicate with the remote control apparatus which is provided with a control surface; and a processor configured to, in response to receiving a signal corresponding to a first user command in which the control surface is touched, control the display to display preview information on a screen, and in response to receiving a signal corresponding to a second user command in which the control surface is pressed, execute a preview information related function.

The preview information related function may include at least one of a first function of displaying visual information related to the preview information on the screen of the display apparatus, a second function of outputting auditory information related to the preview information, and a third function of transmitting data related to the preview information to an external device.

In response to the control surface being allocated to a function related to an application, the preview information may be an application history list including identification information of previously executed applications, and the preview information related function may be a function of displaying an application list including identification information of applications which are executable through the display apparatus.

In response to the control surface being allocated to a function related to a broadcast channel, the preview information may be a broadcast channel history list including identification information of previously viewed broadcast channels, and the preview information related function may be a function of displaying a broadcast channel list including identification information of broadcast channels which provide broadcast contents through the display apparatus.

In addition, in response to the control surface being allocated to a function related to a content, the preview information may be a control menu including identification information of functions for controlling content which is being provided through the display apparatus, and the preview information related function may be a function corresponding to identification information which is selected according to the second user command from among the identification information of the functions included in the control menu.

In addition, in response to the control surface being allocated to a function related to a source device, the preview information may be a source list including identification information of source devices which are able to provide contents through the display apparatus, and the preview information related function may be a function of displaying content or a list of contents included in a source device corresponding to identification information which is selected according to the second user command from among the identification information included in the source list.

In addition, in response to the control surface being allocated to a function related to broadcast channel zapping, the preview information may be EPG information of a previous broadcast channel or next broadcast channel with respect to a current broadcast channel which is being provided through the display apparatus, and a part or a portion of a broadcast content which is being provided in the previous or next broadcast channel, and the preview information related function may be a function of displaying a broadcast content which is being reproduced in the previous or next broadcast channel.

According to yet another aspect of an exemplary embodiment, there is provided a method of controlling a display apparatus by a remote control apparatus, the method including: receiving a first user command in which a control surface is touched or a second user command in which the control surface is pressed or press released; and, in response to the first user command being input, transmitting, to the display apparatus, a signal for displaying preview information on a screen of the display apparatus, and, in response to the second user command being input, transmitting a signal, to the display apparatus, for executing a preview information related function.

In addition, the preview information related function may include at least one of a first function of displaying visual information related to the preview information on the screen of the display apparatus, a second function of outputting auditory information related to the preview information, and a third function of transmitting data related to the preview information to an external device.

According to yet another aspect of an exemplary embodiment, there is provided a method for executing a display apparatus by a remote control apparatus, the method including: communicating with the remote control apparatus provided with a control surface; and, in response to receiving a signal, from the remote control apparatus, according to a first user command in which the control surface is touched, displaying preview information on a screen, and, in response to receiving a signal, from the remote control apparatus, according to a second user command in which the control surface is pressed or press released, executing a preview information related function.

The preview information related function may include at least one of a first function of displaying visual information related to the preview information on the screen of the display apparatus, a second function of outputting auditory information related to the preview information, and a third function of transmitting data related to the preview information to an external device.

According to various exemplary embodiments, a user's menu operation and a time required to search content can be reduced. In addition, a plurality of user commands can be input through the same control surface, such that the remote control apparatus can be easily and simply manipulated. In addition, since preview information corresponding to various functions and contents can be provided by touching a control surface of the remote control apparatus, the user can rapidly identify desired information in advance before a specific content is reproduced or a specific function is directly performed. Accordingly, satisfaction of users using the display apparatus can be enhanced.

Other effects which can be obtained or expected by exemplary embodiments will be directly or implicitly disclosed in the detailed descriptions of exemplary embodiments. For example, various effects which are expected according to exemplary embodiments will be disclosed in the following detailed descriptions.

Additional and/or other aspects will be set forth in part in the description which follows and, in part, will be obvious from the description, or may be learned by practice of exemplary embodiments.

### BRIEF DESCRIPTION OF THE DRAWINGS

The above and/or other aspects will be more apparent by describing certain exemplary embodiments with reference to the accompanying drawings, in which:

FIG. 1 is a view illustration a system according to an exemplary embodiment;

FIG. 2 is a block diagram schematically illustrating a remote control apparatus according to an exemplary embodiment;

FIGS. 3A and 3B are views illustrating user interfaces of the remote control apparatus according to an exemplary embodiment;

FIG. 4 is a block diagram schematically illustrating a display apparatus according to an exemplary embodiment;

FIGS. 5A and 5B are views illustrating a process in which the remote control apparatus controls the display apparatus to execute an application according to an exemplary embodiment;

FIGS. 6A and 6B are views illustrating a process in which the remote control apparatus controls the display apparatus to select a broadcast channel according to an exemplary embodiment;

FIGS. 7A and 7B are views illustrating a process in which the remote control apparatus controls the display apparatus to select a content source device according to an exemplary embodiment;

FIG. 8 is a view illustrating a process in which the remote control apparatus zaps broadcast channels provided by the display apparatus according to an exemplary embodiment;

FIG. 9 is a view illustrating a process in which the remote control apparatus displays Electronic Program Guide (EPG) information of a broadcast content provided in the display apparatus according to an exemplary embodiment;

FIGS. 10A to 10C are views illustrating a process in which the remote control apparatus controls content provided by the display apparatus according to an exemplary embodiment;

FIGS. 11A and 11B are views illustrating a process in which the remote control apparatus controls the display apparatus to select a content source device according to an exemplary embodiment;

FIGS. 12A to 12C are views illustrating a process in which the remote control apparatus selects content to be reproduced in the display apparatus according to an exemplary embodiment;

FIGS. 13A to 13C are views illustrating a process in which the remote control apparatus controls a volume of the display apparatus according to an exemplary embodiment;

FIGS. 14A to 14C are views illustrating a process in which the remote control apparatus selects a broadcast channel of the display apparatus according to an exemplary embodiment;

FIGS. 15A and 15B are views illustrating a process in which the remote control apparatus selects a broadcast channel of the display apparatus according to another exemplary embodiment;

FIG. 16 is a block diagram showing a display apparatus according to another exemplary embodiment;

FIG. 17 is a flowchart illustrating a method of controlling the display apparatus by the remote control apparatus according to an exemplary embodiment; and

FIG. 18 is a flowchart illustrating a method of executing functions of the display apparatus by the remote control apparatus according to an exemplary embodiment.

### DETAILED DESCRIPTION OF THE EXEMPLARY EMBODIMENTS

Hereinafter, exemplary embodiments will be described in detail with reference to the accompanying drawings.

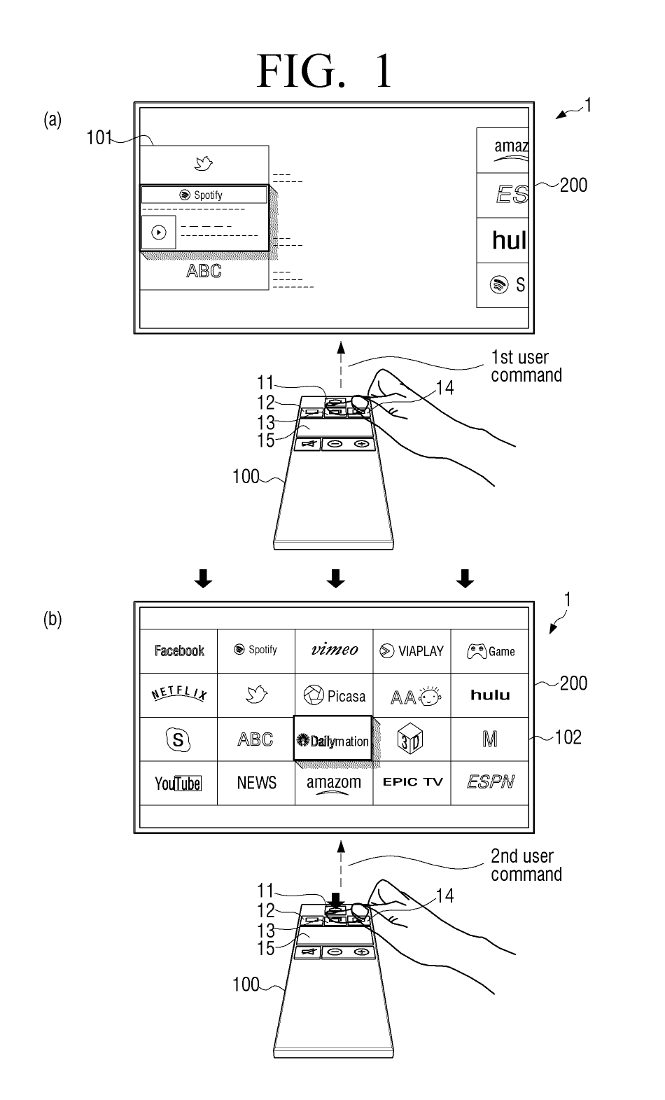

FIG. 1 is a view illustrating a system according to an exemplary embodiment.

Referring to FIG. 1, the system 1 according to an exemplary embodiment includes a remote control apparatus 100 and a display apparatus 200.

The remote control apparatus 100 may control the operation of the display apparatus 200. For example, the remote control apparatus 100 may be implemented in various forms such as a remote controller, a portable terminal like a smart phone, a Portable Multimedia Player, a Personal Digital Assistant (PDA), a notebook computer, or the like.

For example, when the remote control apparatus 100 is implemented in the form of a portable terminal, the remote control apparatus 100 may include a touch screen. In this case, the remote control apparatus 100 may be implemented in the form of a touch-based portable terminal which displays a user interface (UI) screen and controls the displayed UI screen based on a touch interaction using a finger or a pen (for example, a stylus pen). The remote control apparatus 100 may provide the UI screen for controlling the display apparatus 200 on the touch screen, and transmit a signal corresponding to a touch interaction input through the corresponding UI screen to the display apparatus 200. To achieve this, the remote control apparatus 100 may include a touch sensor for receiving various user commands, or an optical joystick (OJ) sensor applying optical technology. In addition, the remote control apparatus 100 may detect a motion of the remote control apparatus 100 and transmit a signal corresponding to the motion, may recognize a voice and transmit a signal corresponding to the recognized voice, or may transmit a signal corresponding to an input key. To achieve this, the remote control apparatus 100 may further include a motion sensor, a microphone, a physical button (for example, a tact switch or the like), or the like.

In another example, the remote control apparatus 100 may be a remote controller which projects an infrared ray of a predetermined frequency onto the display apparatus 200 according to a user's manipulation and controls the operation of the display apparatus. In this case, the display apparatus 200 may receive the projected infrared ray and convert the infrared ray into an electric signal corresponding to the frequency of the infrared ray, and may perform various operations such as changing a channel, adjusting a volume, or the like.

The user may request the display apparatus 200 to provide a content using the remote control apparatus 100, and may control the display apparatus 200 providing the content. For example, in response to the user selecting a channel using the remote control apparatus 100, the display apparatus 200 may display content of the channel selected through the remote control apparatus 100.

The remote control apparatus 100 may include a plurality of control surfaces 11, 12, 13, 14, and 15 for detecting user's touch. The plurality of control surfaces 11-15 may be physically spaced apart from one another. Alternatively, a single control surface may be divided into areas and the divided areas may be implemented as the plurality of control surfaces 11-15.

The user may perform various control operations such as selecting a channel of the display apparatus 200, adjusting a volume, selecting an external input mode, executing an application program, or the like using the control surfaces. To achieve this, the control surfaces may be implemented by using at least one of a touch pad and a trackpad for detecting user's touch. In this case, the touch pad may detect not only the user's touch but also a pressure of the user's touch.

The display apparatus 200 may be implemented by using a digital TV as shown in FIG. 1, but this should not be considered as limiting and is provided by way of an example only. The display apparatus 200 may be implemented by using various types of apparatuses provided with a display function, such as a personal computer (PC), a navigation device, a kiosk, a digital information display (DID), or the like.

According to an exemplary embodiment, the remote control apparatus 100 may receive a first user command of touching the control surface 13 in a state as shown in view (a) of FIG. 1. Accordingly, the remote control apparatus 100 may transmit, to the display apparatus 200, a signal for displaying preview information 101 on the screen of the display apparatus 200. In this case, when the control surface 13 is implemented by using a touch pad, the first user command of touching the control surface 13 may be a user touch command having a pressure which is lower than or equal to a threshold value. In addition, when the control surface 13 is implemented by using a trackpad, the first user command of touching the control surface 13 may be a user command of touching the trackpad.

For example, the signal for displaying the preview information 101 may include an event signal for informing that the control surface 13 has been touched or a request signal for requesting display of the preview information 101. In response to the received signal, the display apparatus 200 may display the preview information 101 on the screen. For example, the display apparatus 200 may display the preview information 101 on a part of the screen (for example, the center or one side of the screen). In this case, in response to a predetermined time (for example, 0.3 to 0.7 second) elapsing after the control surface 13 is touched, the display apparatus 200 may display the preview information 101 on the screen.

For example, the preview information may be at least one of use history information of the display apparatus 200, a thumbnail of content, a thumbnail of a menu, a control menu of content, EPG information, and a portion of content, but is not limited to the above-mentioned examples.

According to an exemplary embodiment, the remote control apparatus 100 may receive a second user command of pressing the control surface 13 or removing the press of the control surface 13 after the initial pressing as shown in view (b) of FIG. 1. Alternatively, in the state in which the remote control apparatus 100 receives the first user command of touching the control surface 13, the remote control apparatus 100 may receive the second user command of continuously pressing the touched control surface 13 or removing the press of the control surface 13 after the initial pressing. In this case, when the control surface 13 is implemented by using a touch pad, the second user command of pressing the control surface 13 may be a user touch command having a pressure exceeding the threshold value. In addition, when the control surface 13 is implemented by using a trackpad, the second user command of pressing the control surface 13 may be a user command of pressing a button included in the trackpad.

In this case, the remote control apparatus 100 may transmit a signal for executing a function related to the preview information 101 to the display apparatus 200. For example, the signal for executing the function related to the preview information 101 may include an event signal informing that the control surface 13 has been pressed or a request signal for requesting the execution of the function related to the preview information 101.

In response to the received signal, the display apparatus 200 may execute the function related to the preview information 101. For example, the display apparatus 200 may display visual information 102 related to the preview information 101 on the screen. In this case, the display apparatus 200 may display the visual information 102 related to the preview information 101 on a part or entirety of the screen.

The displaying the visual information on the entirety of the screen may mean that the visual information is displayed such that at least one of width and height of the visual information is the same as or close to at least one of width and height of the screen. In addition, the visual information may be content, a menu, a list of applications, a list of contents, a list of broadcast channels, a list of sources, or the like, for example, but is not limited to the above-mentioned examples.

Alternatively, the display apparatus 200 may output auditory information related to the preview information as the function related to the preview information 101. In this case, the auditory information related to the preview information may be an audio such as music, a beep sound, a sound effect, or the like, for example. Alternatively, the display apparatus 200 may transmit data related to the preview information 101 to an external device as the function related to the preview information 101. The data related to the preview information may be shared data stored in the external device (for example, a server) or control data for controlling the function of the external device, for example.

In the state as shown in view (a) of FIG. 1, the remote control apparatus 100 may receive a user command of swiping while still touching the entirety of the plurality of control surfaces 12, 13, and 14. In this case, the remote control apparatus 100 may transmit, to the display apparatus 200, a signal for displaying preview information corresponding to the plurality of control surfaces 12, 13, and 14 on the screen of the display apparatus 200.

In response to the received signal, the display apparatus 200 may display a plurality of pieces of preview information on the screen in sequence. Alternatively, the display apparatus 200 may display the plurality of pieces of preview information on the screen simultaneously. These examples are not limiting.

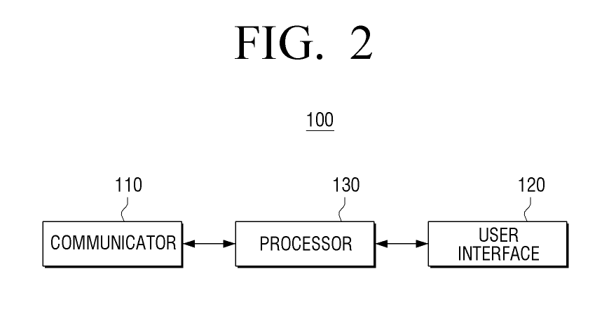

FIG. 2 is a block diagram schematically illustrating the remote control apparatus 100 according to an exemplary embodiment.

Referring to FIG. 2, the remote control apparatus 100 according to an exemplary embodiment includes a communicator 110, a user interface 120, and a processor 130.

The communicator 110 is configured to communicate with the display apparatus 200. Specifically, the communicator 110 may communicate with the display apparatus 200 according to a short distance wireless communication method such as Radio Frequency (RF) communication including Bluetooth, Zigbee, WiFi, or the like, or Infrared Ray (IR) communication. To achieve this, the communicator 110 may include a communication module which is used in each communication method. In an exemplary embodiment, a communicator 110 is a transceiver, which transmits and receives signals to and from the display apparatus.

In response to a predetermined event occurring, the communicator 110 may communicate with the display apparatus 200 according to a pre-defined communication method and thereby enter an interlocking state. Herein, the interlocking refers to any state in which communication is possible, such as a state in which communication between the remote control apparatus 100 and the display apparatus 200 is initialized, a state in which a network is formed, a state in which device pairing is performed, or the like.

For example, in response to communication being performed according to the Bluetooth communication method, the communicator 110 may perform pairing with the display apparatus 200 through a Bluetooth communication module, and may enter the communication enabled state with the display apparatus 200.

In addition, in response to a Zigbee communication module being provided, the communicator 110 may perform pairing with the display apparatus 200 through a Zigbee communication module and enter the communication enabled state with the display apparatus 200.

In addition, the communicator 110 may wirelessly communicate with the display apparatus 200 using WiFi or the like. For example, the communicator 110 may be directly connected with the display apparatus 200 through a WiFi communication module without passing through a separate network, and may communicate with the display apparatus 200, or may be connected to a network using an Access Point (AP) or the like and may communicate with the display apparatus 200. As described above, the communicator 110 may communicate with the display apparatus 200 using various communication methods, according to an exemplary embodiment.

Herein, the predetermined event may occur in at least one of the remote control apparatus 100 and the display apparatus 200. For example, the predetermined event may refer to a case in which a user command to select the display apparatus 200 as a controlled device is input through the remote control apparatus 100 or a case in which the display apparatus 200 is turned on.

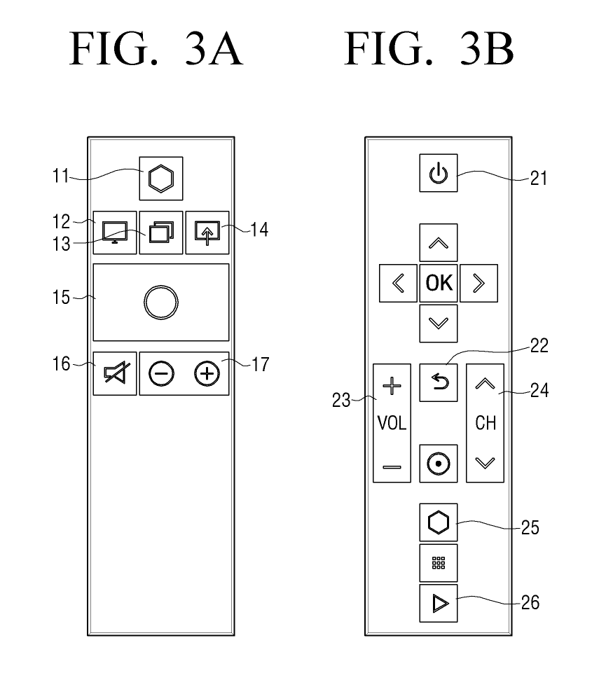

The user interface 120 is configured to receive a user command. The user interface 120 may include a plurality of control surfaces for receiving various user commands for controlling the functions of the display apparatus. The plurality of control surfaces may be allocated functions for controlling the display apparatus 200. The functions allocated to the plurality of control surfaces will be described in detail below in FIG. 3.

In addition, the user interface 120 may receive the first user command of touching a control surface and the second user command of pressing a control surface or removing the press after the initial pressing.

The processor 130 may control the overall operation of the remote control apparatus 100.

For example, in response to the first user command of touching a control surface being input, the processor 130 may control the communicator 110 to transmit the signal for displaying the preview information on the screen of the display apparatus 200 to the display apparatus 200. In addition, in response to the second user command of pressing a control surface or removing the press after the initial pressing being input, the processor 130 may control the communicator 110 to transmit the signal for executing the function related to the preview information to the display apparatus 200.

In this case, the function related to the preview information may be at least one of a function of displaying visual information related to the preview information on the screen of the display apparatus 200, a function of outputting auditory information related to the preview information, and a function of transmitting data related to the preview information to an external device.

According to an exemplary embodiment, in response to the control surface being a control surface allocated a function related to an application, the preview information may be an application history list including identification information of applications which have a history of having been executed by the user through the display apparatus 200, and the function related to the preview information may be a function of displaying a list of applications including identification information of applications which are executable through the display apparatus 200.

According to an exemplary embodiment, in response to the control surface being a control surface allocated a function related to a broadcast channel, the preview information may be a broadcast channel history list including identification information of broadcast channels which have a history of having been viewed by the user through the display apparatus 200, and the function related to the preview information may be a function of displaying a list of broadcast channels including identification information of broadcast channels which can provide broadcast contents through the display apparatus 200.

According to an exemplary embodiment, in response to the control surface being a control surface allocated a function related to content, the preview information may be a control menu including identification information of functions for controlling content which is being provided through the display apparatus 200, and the function related to the preview information may be a function corresponding to identification information which is selected according to the second user command from among the identification information of the functions included in the control menu.

According to an exemplary embodiment, in response to the control surface being a control surface allocated a function related to a source device, the preview information may be a source list including identification information of source devices which can provide contents through the display apparatus 200, and the function related to the preview information may be a function of displaying content or a list of contents included in a source device corresponding to identification information which is selected according to the second user command from among the identification information included in the source list.

According to an exemplary embodiment, in response to the control surface being a control surface allocated a function related to broadcast channel zapping, the preview information may be EPG information of a previous or next broadcast channel of a current broadcast channel which is being provided through the display apparatus 200, or a part of a broadcast content which is being provided in the previous or next broadcast channel, and the function related to the preview information may be a function of displaying a broadcast content which is being reproduced in the previous or next broadcast channel of the current broadcast channel.

FIGS. 3A and 3B are views illustrating user interfaces of the remote control apparatus 100 according to an exemplary embodiment.

In FIGS. 3A and 3B, the remote control apparatus 100 may include a plurality of control surfaces for receiving a user command according to an exemplary embodiment.

In FIGS. 3A and 3B, the plurality of control surfaces may be implemented by using at least one of a touch pad and a trackpad for detecting a user's touch. In addition, at least one of the plurality of control surfaces may be implemented by using a physical button.

According to an exemplary embodiment, in the remote control apparatus 100 as shown in FIG. 3A, a function allocated to a control surface 11 may be a function of displaying a hub screen (for example, a smart hub screen of Samsung) on the screen of the display apparatus 200. For example, the hub screen may be a platform screen which is provided by the manufacturer of the display apparatus 200 and may provide various functions which can be performed in the display apparatus 200. In addition, a function allocated to a control surface 12 may be a function of selecting a broadcast channel which can be provided by the display apparatus 200. In addition, a function allocated to a control surface 13 may be a function of executing an application which can be provided by the display apparatus 200. In addition, a function allocated to a control surface 14 may be a function of selecting a source device which will provide content to the display apparatus 200.

In response to a user command of touching or pressing the control surfaces 11 to 14 being input, the remote control apparatus 100 may transmit signals for performing the above-described functions to the display apparatus 200.

In addition, a function allocated to a control surface 15 may be a function of changing a channel which is being provided by the display apparatus 200. For example, in response to a user command of touching or pressing the control surface 15 being input, the remote control apparatus 100 may change or select a channel which is being provided by the display apparatus 200.

In addition, a function allocated to a control surface 16 may be a function of changing a volume of the display apparatus 200 to a mute mode or an audible mode.

In addition, a function allocated to a control surface 17 may be a function of turning up or down the volume of the display apparatus 200.

In response to a user command of pressing the control surface 16 and the control surface 17 being input, the remote control apparatus 100 may transmit signals for performing the above-described functions to the display apparatus 200.

According to an exemplary embodiment, in the remote control apparatus 100 as shown in FIG. 3B, a function allocated to a control surface 21 may be a function of turning on or off the display apparatus 200. In addition, the function allocated to the control surface 21 may be a function of selecting a source device which will provide content.

In addition, a function allocated to a control surface 22 may be a function of changing a current screen displayed on the display apparatus 200 to a previous screen. Alternatively, the function allocated to the control surface 22 may be a function of changing a current state of the display apparatus 200 to a previous state. For example, when the current state of the display apparatus 200 is a state in which certain content is being reproduced, the previous state may be a state in which content which has been reproduced before the current content is reproduced is reproduced again.

In addition, a function allocated to a control surface 23 may be a function of controlling a volume output from the display apparatus 200.

In addition, a function allocated to a control surface 24 may be a function of selecting a broadcast channel which can be provided by the display apparatus 200.

In addition, a function allocated to a control surface 25 may be a function of displaying a hub screen on the screen of the display apparatus 200.

In addition, a function allocated to a control surface 26 may be a function of controlling content provided by the display apparatus 200.

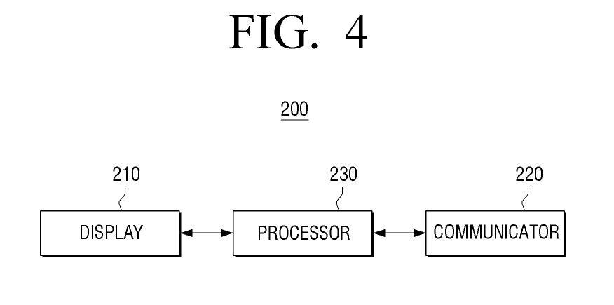

FIG. 4 is a block diagram schematically illustrating the display apparatus 200 according to an exemplary embodiment.

For example, the display apparatus 200 may display content which is received through a video signal such as a TV signal or the like. The display apparatus 200 may output a video and a sound to the outside simultaneously and thereby provide various audio-visual contents to the user.

The display apparatus 200 may include an infrared ray receiver which receives an infrared ray projected from the remote control apparatus 100 in an IR communication method in order to be controlled by the remote control apparatus 100, or may include a transceiver for receiving a predetermined control command from the remote control apparatus 100 in an RF communication method, for example, an RF communication module.

The display apparatus 200 may be various types of display apparatuses which can be controlled by the remote control apparatus 100. For example, the display apparatus 200 may be any device which can display an image through a screen, such as a TV including a smart TV, a computer, or the like.

Referring to FIG. 4, the display apparatus 200 according to an exemplary embodiment may include a display 210, a communicator 220, and a processor 230.

The display 210 may display a screen including various types of contents. In addition, the display 210 may display a screen including a UI for interacting with the user. For example, the display 210 may display an environment setting menu, adjustment information of a channel and volume, or a variety of information about contents.

The display 210 may be implemented by using a Liquid Crystal Display (LCD) panel, an Organic Light Emitting Diode (OLED), or the like, but these are provided by way of an example and not by way of a limitation. In addition, the display 210 may be implemented by using a flexible display, a transparent display, or the like.

The communicator 220 may communicate with the remote control apparatus 100. The communicator 220 may communicate with the remote control apparatus 100 according to a short distance wireless communication method such as IR communication including Bluetooth, Zigbee, WiFi, or the like, or IR communication. To achieve this, the communicator 220 may include a communication module which is used in each communication method. The communicator 220 may be a transceiver configured to transmit and receive signals to and from the remote control apparatus 100.

The display apparatus 200 may include a communication module to communicate in the same way as the communicator 110 of the remote control apparatus 100, and the method for the remote control apparatus 100 to communicate with the display apparatus 200 has been described in detail in FIG. 2, and thus a detailed description thereof is omitted.

The processor 230 is configured to perform the overall operation of the display apparatus 200.

In particular, in response to a signal corresponding to a first user command of touching a control surface of the remote control apparatus 100 being received from the remote control apparatus 100, the processor 230 may control the display 210 to display preview information on the screen. In addition, in response to a signal corresponding to a second user command of pressing a control surface of the remote control apparatus 100 or in response to a signal indicating that the pressing has stopped after the initial pressing being received from the remote control apparatus 100, the processor 230 may execute a function related to the preview information.

In this case, the function related to the preview information may include at least one of a function of displaying visual information related to the preview information on the screen of the display apparatus 200, a function of outputting auditory information related to the preview information, and a function of transmitting data related to the preview information to an external device.

In response to the control surface being a control surface allocated a function related to an application, the preview information may be an application history list including identification information of applications which have a history of having been executed by the user through the display apparatus 200, and the function related to the preview information may be a function of displaying a list of applications including identification information of applications which are executable through the display apparatus 200.

In addition, in response to the control surface being a control surface allocated a function related to a broadcast channel, the preview information may be a broadcast channel history list including identification information of broadcast channels which have a history of having been viewed by the user through the display apparatus 200, and the function related to the preview information may be a function of displaying a list of broadcast channels including identification information of broadcast channels which can provide broadcast contents through the display apparatus 200.

In addition, in response to the control surface being a control surface allocated a function related to content, the preview information may be a control menu including identification information of functions for controlling content which is being provided through the display apparatus 200, and the function related to the preview information may be a function corresponding to identification information which is selected according to the second user command from among the identification information of the functions included in the control menu.

According to an exemplary embodiment, in response to the control surface being a control surface allocated a function related to a source device, the preview information may be a source list including identification information of source devices which can provide contents through the display apparatus 200, and the function related to the preview information may be a function of displaying content or a list of contents included in a source device corresponding to identification information which is selected according to the second user command from among the identification information included in the source list.

In addition, in response to the control surface being a control surface allocated a function related to broadcast channel zapping, the preview information may be EPG information of a previous or next broadcast channel with respect to a currently viewed broadcast channel which is being provided through the display apparatus 200, or a part of a broadcast content which is being provided in the broadcast channel, and the function related to the preview information may be a function of displaying broadcast content which is being reproduced in the previous or next broadcast channel with respect to the currently viewed broadcast channel.

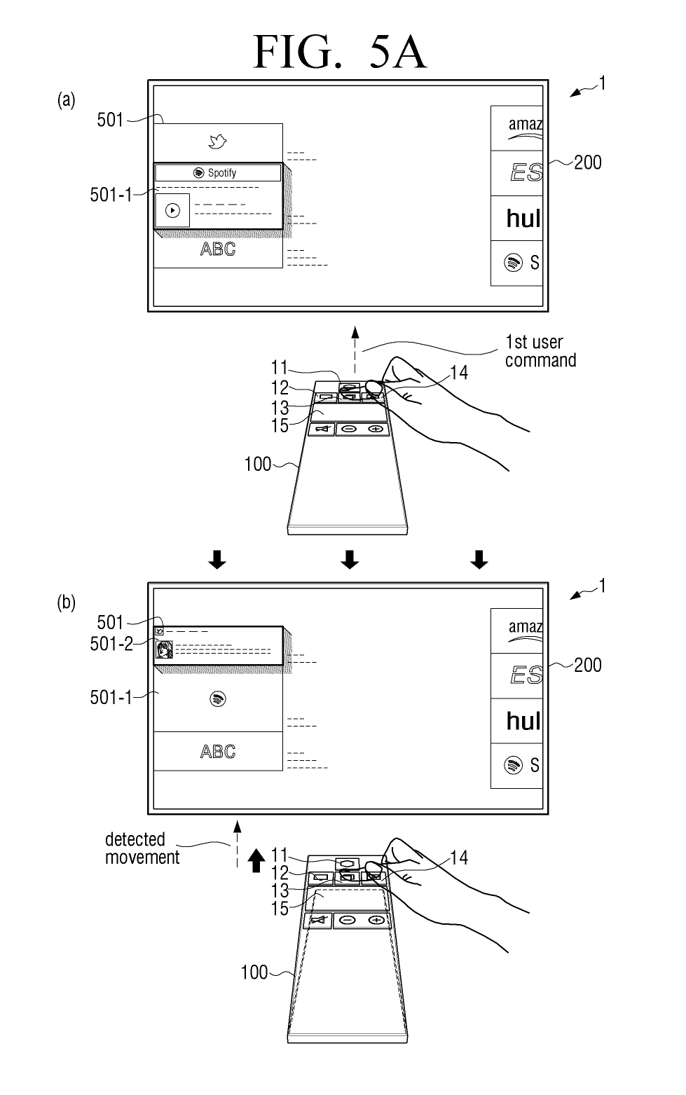

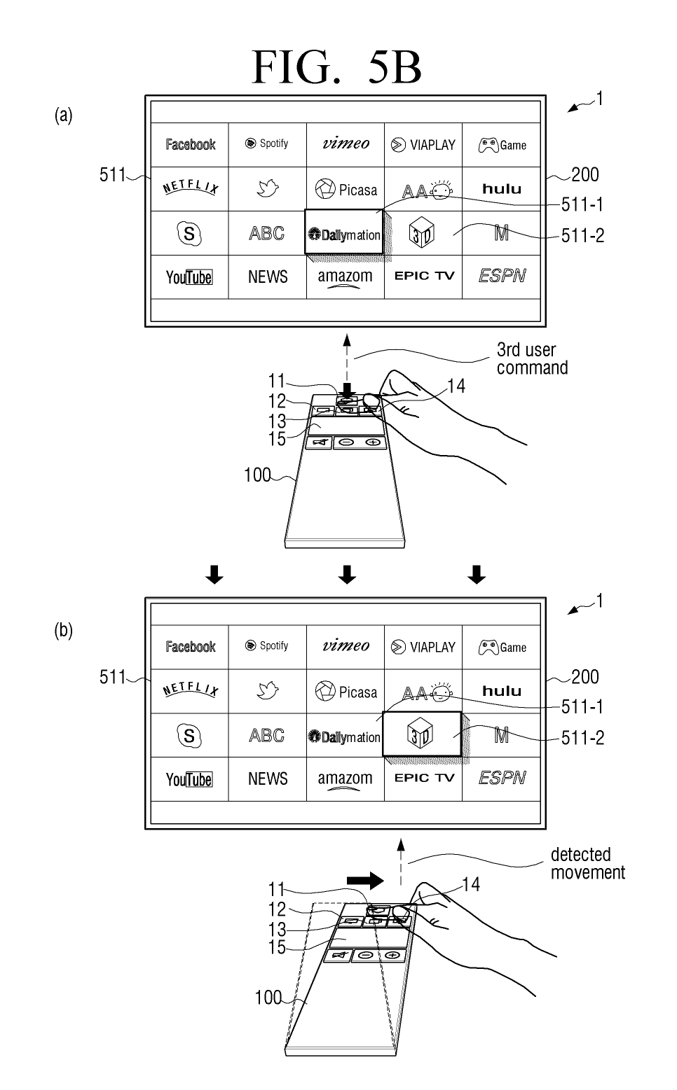

FIGS. 5A and 5B are views illustrating a process in which the remote control apparatus 100 controls the display apparatus 200 to execute an application according to an exemplary embodiment.

Referring to FIGS. 5A and 5B, the remote control apparatus 100 may receive a user command of selecting one control surface 13. In this case, the control surface 13 may be a control surface allocated a function related to an application.

According to an exemplary embodiment, in the state as shown in view (a) of FIG. 5A, the remote control apparatus 100 may receive a first user command of touching the control surface 13. In response to the first user command, the remote control apparatus 100 may transmit, to the display apparatus 200, a signal for displaying preview information related to an application on the screen of the display apparatus 200.

In response to the received signal, the display apparatus 200 may display, on the screen, a list 501 including identification information of applications which have a history of having been executed by the user, as the preview information. For example, the display apparatus 200 may display a list including identification information of applications which are listed in order of execution, beginning with the most recently executed application. In this case, identification information 501-1 of a certain application included in the list of applications may be highlighted. In an exemplary embodiment, the highlighting may mean that a specific item included in a certain list is distinguished from at least one other item included in the certain list. For example, the highlighted item may have at least one of different color, a different edge, different shade, a different contrast, a different size, a different font, a different visual effect, and a different auditory effect from the other items included in the list. These are provided by way of an example and not by way of a limitation.

Next, as shown in view (b) of FIG. 5A, the remote control apparatus 100 may detect a movement of the remote control apparatus 100 in one direction (for example, one of the up/down/left/right directions). According to the direction of the detected movement, the remote control apparatus 100 may transmit a signal to the display apparatus 200 for moving the highlight location on the screen of the display apparatus 200 to a different location. In this case, the transmitted signal may include a sensing value which is obtained by the remote control apparatus 100 using an acceleration sensor according to the movement of the remote control apparatus 100. Alternatively, the signal may include a signal for the remote control apparatus 100 to request change of the highlight location on the screen of the display apparatus 200 to a different location based on the sensing value.

In response to the received signal, the display apparatus 200 may change the highlight location on the screen of the display apparatus 200 to a different location. For example, the display apparatus 200 may change the location of the highlight indicating the identification information 501-1 of one application included in the application list to indicate identification information 501-2 of another application. For example, in response to receiving information about an upward movement of the remote control apparatus 100, the display apparatus 200 may change the highlight location such that the identification information 501-2 of another application located above the identification information 501-1 of one application is highlighted.

Next, the remote control apparatus 100 may receive a second user command of pressing the control surface 13 while still touching or the touching or pressing of the control surface 13 may be stopped after the initial pressing. In response to the second user command, the remote control apparatus 100 may transmit a signal for displaying an execution screen of an application to the display apparatus 200.

In response to the received signal, the display apparatus 200 may execute an application corresponding to the highlighted identification information 501-2 of the application, and display the execution screen of the executed application on the screen of the display apparatus 200.

Referring to view (a) of FIG. 5B, according to another exemplary embodiment, the remote control apparatus 100 may receive a third user command of pressing the control surface 13 or removing or stopping the pressing after the initial pressing. In response to the third user command, the remote control apparatus 100 may transmit a signal for executing a function related to the preview information to the display apparatus 200.

In response to the received signal, the display apparatus 200 may execute the function related to the preview information. For example, the display apparatus 200 may display a list 511 of applications which can be executed by the user. The list 511 of applications may include not only applications which have been executed by the user in the past but also applications which have not been executed by the user. In addition, the list 511 of applications may include not only applications which are installed in the display apparatus 200 but also applications which are not installed in the display apparatus 200 but can be received from external devices (not shown) and executed by the user.

Next, in view (a) of FIG. 5B, the remote control apparatus 100 may detect a movement of the remote control apparatus 100 in one direction (for example, one of the up/down/left/right directions). According to the direction of the detected movement, the remote control apparatus 100 may transmit a signal for moving a highlight location on the screen of the display apparatus 200 to a different location to the display apparatus 200.

For example, in the state in which the user stops pressing on the control surface 13, in response to the user moving the remote control apparatus 100 in one direction, the remote control apparatus 100 may obtain a sensing value according to a movement direction using the acceleration sensor. In order to change the highlight location on the screen of the display apparatus 200 to a different location based on the obtained sensing value, the remote control apparatus 100 may transmit, to the display apparatus 200, information on the movement direction or the sensing value according to the movement.

In response to the received information or sensing value, the display apparatus 200 may change the highlight location on the screen of the display apparatus 200 to a different location. For example, the display apparatus 200 may change the location of the highlight indicating identification information 511-1 of one application included in the application list 511 to indicate identification information 511-2 of another application. For example, in response to information on the leftward movement of the remote control apparatus 100 being received, the display apparatus 200 may change the highlight location such that the identification information 511-2 of another application located on the left of the identification information 511-1 of one application is highlighted as shown in view (b) of FIG. 5B.

Next, the remote control apparatus 100 may receive a fourth user command of pressing the control surface 13 again. In response to the fourth user command, the remote control apparatus 100 may transmit a signal for displaying the execution of an application to the display apparatus 200.

In response to the received signal, the display apparatus 200 may execute an application corresponding to the highlighted identification information 511-2 of the application and display the execution screen of the executed application on the screen of the display apparatus 200.

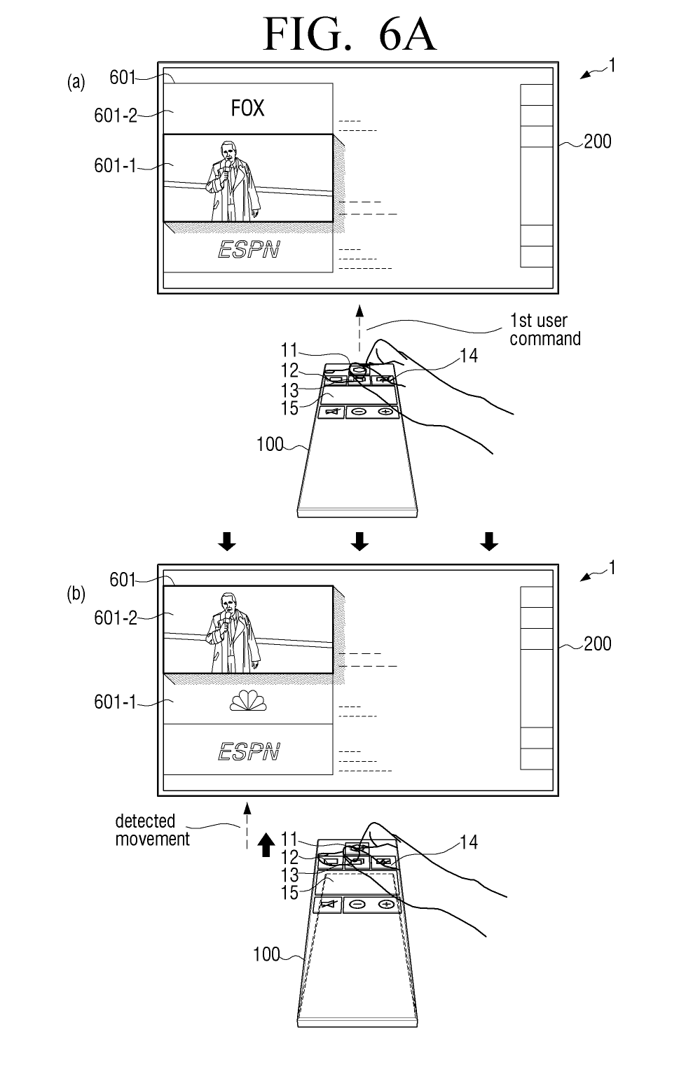

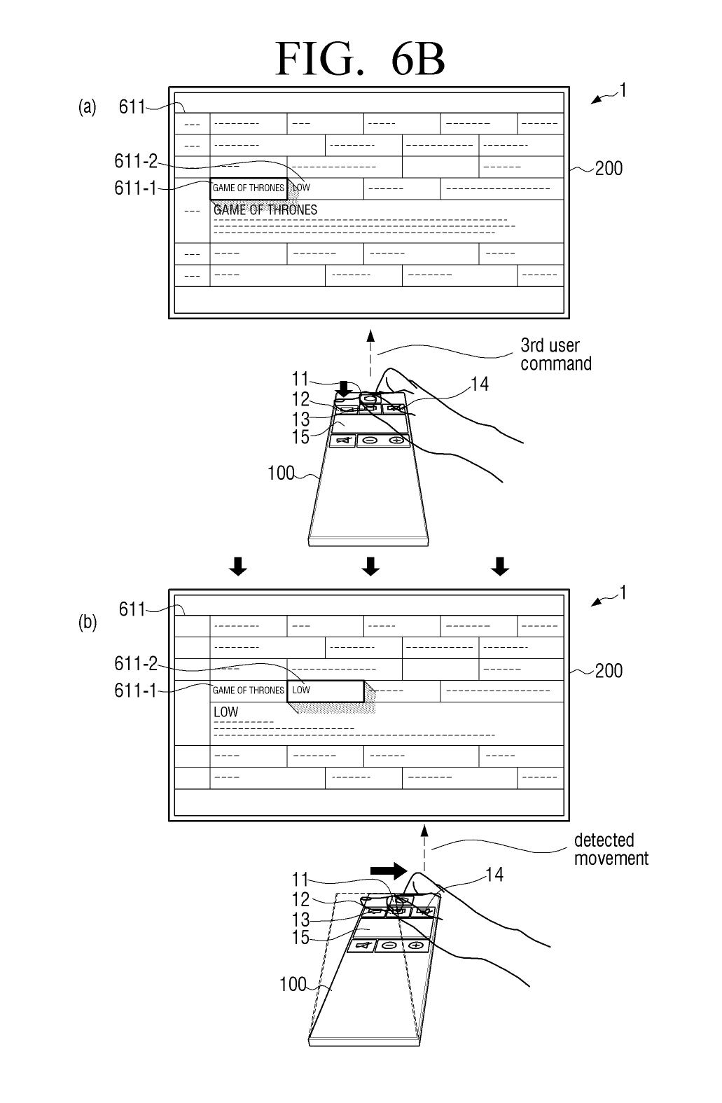

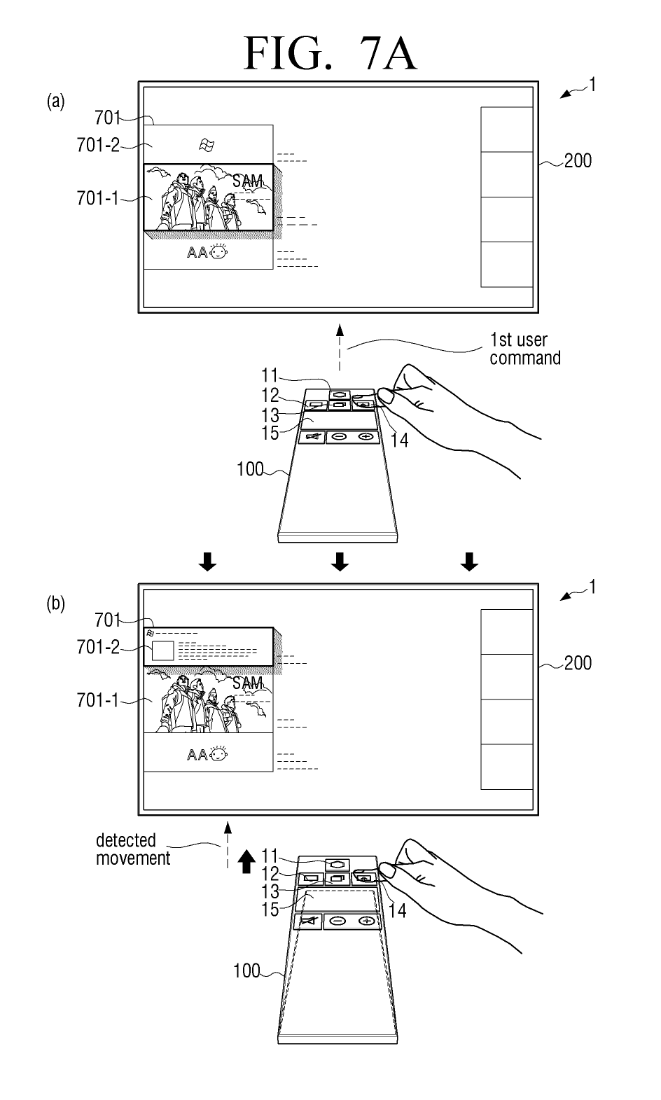

FIGS. 6A and 6B are views illustrating a process in which the remote control apparatus 100 controls the display apparatus 200 to select a broadcast channel according to an exemplary embodiment.

Referring to FIGS. 6A and 6B, the remote control apparatus 100 may receive a user command of selecting a control surface 12. In this case, the control surface 12 may be a control surface allocated a function related to a broadcast channel.

According to an exemplary embodiment, referring to view (a) of FIG. 6A, the remote control apparatus 100 may receive a first user command of touching the control surface 12. In response to the first user command, the remote control apparatus 100 may transmit, to the display apparatus 200, a signal for displaying preview information related to a broadcast channel on the screen of the display apparatus 200.

In response to the received signal, the display apparatus 200 may display a list 601 including identification information of broadcast channels which have a history of having been viewed by the user on the screen as the preview information. For example, the display apparatus 200 may display the list 601 including the identification information of broadcast channels which are listed in order of execution, beginning with the most recently executed channel. In this case, identification information 601-1 of one broadcast channel included in the list 601 of the broadcast channels may be highlighted.

Next, in view (a) of FIG. 6A, the remote control apparatus 100 may detect a movement of the remote control apparatus 100 in one direction (for example, one of the up/down/left/right directions). According to the direction of the detected movement, the remote control apparatus 100 may transmit a signal for moving the highlight location on the screen of the display apparatus 200 to a different location to the display apparatus 200.

As shown in view (b) of FIG. 6A, in response to the received signal, the display apparatus 200 may change the location of the highlight indicating the identification information 601-1 of one broadcast channel included in the list of broadcast channels having the history of having been viewed to indicate identification information 601-2 of another broadcast channel.

Next, the remote control apparatus 100 may receive a second user command of pressing the control surface 12 while still touching or removing or stopping the pressing of the control surface 12 after the initial pressing. In response to the second user command, the remote control apparatus 100 may transmit a signal for displaying a content of a broadcast channel to the display apparatus 200.

In response to the received signal, the display apparatus 200 may execute a broadcast channel corresponding to the highlighted identification information 601-2 of the broadcast channel, and display the content of the executed broadcast channel on the screen of the display apparatus 200.

Referring to view (a) of FIG. 6B, according to another exemplary embodiment, the remote control apparatus 100 may receive a third user command of pressing the control surface 12 or removing or stopping the pressing after the initial pressing. In response to the third user command, the remote control apparatus 100 may transmit a signal for executing a function related to the preview information to the display apparatus 200.

In response to the received signal, the display apparatus 200 may execute the function related to the preview information. For example, the display apparatus 200 may display a list 611 of broadcast channels which can be selected by the user.

Next, in view (a) of FIG. 6B, the remote control apparatus 100 may detect a movement of the remote control apparatus 100 in one direction (for example, one of the up/down/left/right directions). According to the direction of the detected movement, the remote control apparatus 100 may transmit a signal for moving a highlight location on the screen of the display apparatus 200 to a different location to the display apparatus 200, as shown in view (b) of FIG. 6B.

In response to the received signal, the display apparatus 200 may change the location of the highlight indicating identification information 611-1 of one broadcast channel included in the list 611 of the broadcast channels to indicate identification information 611-2 of another broadcast channel.

Next, the remote control apparatus 100 may receive a fourth user command of pressing the control surface 12 again. In response to the fourth user command, the remote control apparatus 100 may transmit a signal for displaying the content of the broadcast channel to the display apparatus 200.

In response to the received signal, the display apparatus 200 may execute the broadcast channel corresponding to the highlighted identification information 611-2 of the broadcast channel and display the content of the executed broadcast channel on the screen of the display apparatus 200.

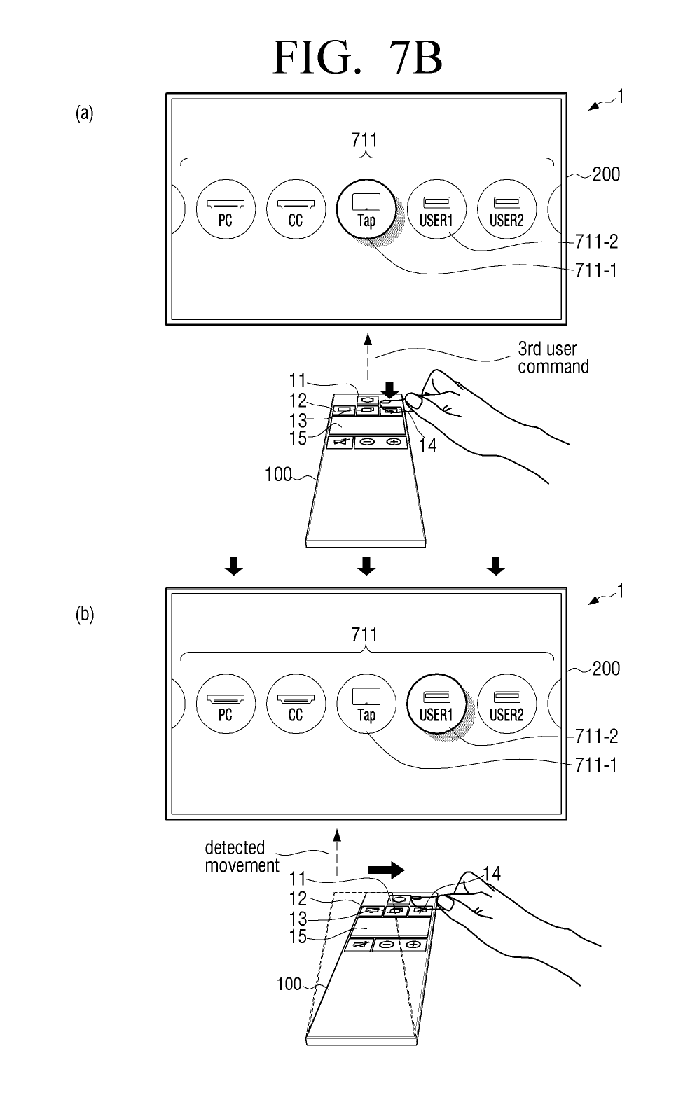

FIGS. 7A and 7B are views illustrating a process in which the remote control apparatus 100 controls the display apparatus 200 to select a content source device according to an exemplary embodiment.

Referring to FIGS. 7A and 7B, the remote control apparatus 100 may receive a user command of selecting a control surface 14. In this case, the control surface 14 may be a control surface allocated a function related to a source device.

According to an exemplary embodiment, referring to view (a) of FIG. 7A, the remote control apparatus 100 may receive a first user command of touching the control surface 14. In response to the first user command, the remote control apparatus 100 may transmit, to the display apparatus 200, a signal for displaying preview information related to a source device on the screen of the display apparatus 200.

In response to the received signal, the display apparatus 200 may display a list 701 including identification information of source devices which have a history of having provided contents on the screen as the preview information. For example, the display apparatus 200 may display the list 701 including the identification information of source devices which are listed in order of providing contents, beginning with the source device most recently providing content. In this case, identification information 701-1 of one source device included in the list may be highlighted.

Next, in view (b) of FIG. 7A, the remote control apparatus 100 may detect a movement of the remote control apparatus 100 in one direction (for example, one of the up/down/left/right directions). According to the direction of the detected movement, the remote control apparatus 100 may transmit a signal for moving the highlight location on the screen of the display apparatus 200 to a different location to the display apparatus 200.

As shown in view (b) of FIG. 7A, in response to the received signal, the display apparatus 200 may change the location of the highlight indicating identification information 701-1 of one source device included in the list 701 of the identification information of the source devices to indicate identification information 701-2 of another source device.

Next, the remote control apparatus 100 may receive a second user command of pressing the control surface 14 while still touching. Alternatively, the remote control apparatus 100 may receive a second user command of removing or stopping a touch or pressing on the control surface 14. In response to the second user command, the remote control apparatus 100 may transmit a signal for displaying content or a list of contents included in a source device to the display apparatus 200.

For example, in response to the received signal, the display apparatus 200 may display content or a list of contents included in the source device corresponding to the highlighted identification information 701-2 of the source device on the screen of the display apparatus 200.

Referring to view (a) of FIG. 7B, according to another exemplary embodiment, the remote control apparatus 100 may receive a third user command of pressing the control surface 14 or removing or stopping the pressing of the control surface 14 after the initial pressing. In response to the third user command, the remote control apparatus 100 may transmit a signal for executing a function related to the preview information to the display apparatus 200.

In response to the received signal, the display apparatus 200 may execute the function related to the preview information. For example, the display apparatus 200 may display a list 711 of source devices which can provide contents to the display apparatus 200.

Next, in view (b) of FIG. 7B, the remote control apparatus 100 may detect a movement of the remote control apparatus 100 in one direction (for example, one of the up/down/left/right directions). According to the direction of the detected movement, the remote control apparatus 100 may transmit a signal for moving a highlight location on the screen of the display apparatus 200 to a different location to the display apparatus 200.

As shown in view (b) of FIG. 7B, in response to the received signal, the display apparatus 200 may change the location of the highlight indicating identification information 711-1 of one source device included in the list 711 of the source devices to indicate identification information 711-2 of another source device.

Next, the remote control apparatus 100 may receive a fourth user command of pressing the control surface 14 again. In response to the fourth user command, the remote control apparatus 100 may transmit a signal for displaying content or a list of contents included in a source device to the display apparatus 200.

In response to the received signal, the display apparatus 200 may display content or a list of contents included in the source device corresponding to the highlighted identification information 711-2 of the source device on the screen of the display apparatus 200.

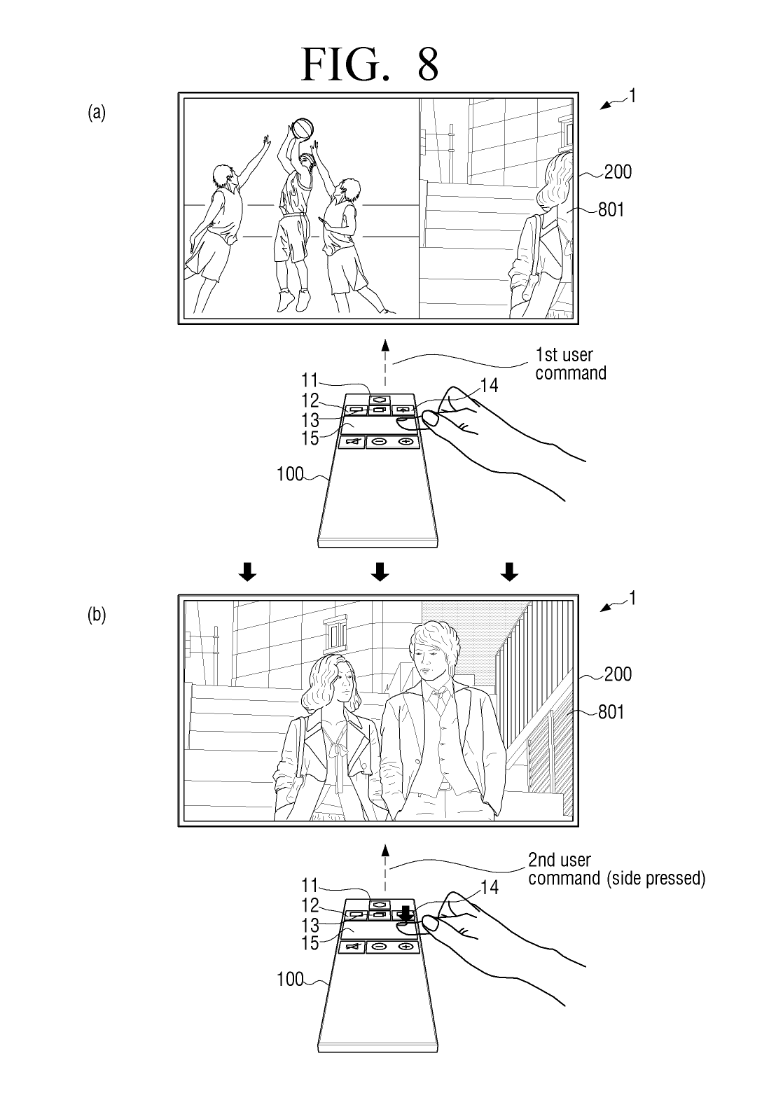

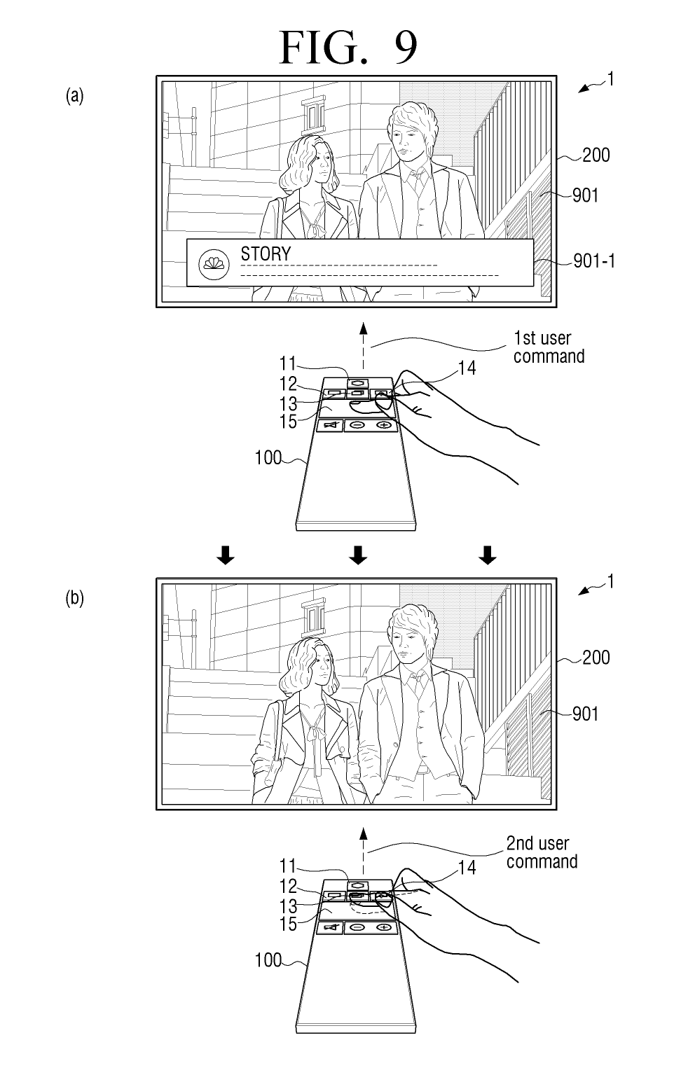

FIG. 8 is a view illustrating a process in which the remote control apparatus 100 zaps broadcast channels provided in the display apparatus 200 according to an exemplary embodiment.

Referring to FIG. 8, the remote control apparatus 100 may receive a user command of selecting a control surface 15. In this case, the control surface may be a control surface allocated a function related to broadcast channel zapping.

Referring to view (a) of FIG. 8, according to an exemplary embodiment, the remote control apparatus 100 may receive a first user command of touching one side of the control surface 15. In response to the first user command, the remote control apparatus 100 may transmit, to the display apparatus 200, a signal for displaying preview information related to a broadcast channel corresponding to one side on the screen of the display apparatus 200.

In response to the received signal, the display apparatus 200 may display a part of a broadcast content 801 which is being provided in a broadcast channel corresponding to one side, or EPG information as the preview information. For example, in response to a signal indicating that the right side of the control surface 15 is touched being received, the display apparatus 200 may display, as the preview information, a part of the broadcast content 801 which is being provided in a next broadcast channel of a currently reproduced broadcast channel, or EPG information of broadcast channels. Alternatively, in response to a signal indicating that the left side of the control surface 15 is touched being received, the display apparatus 200 may display, as the preview information, a part of a broadcast content which is being provided in a previous broadcast channel of the currently reproduced broadcast channel, or EPG information of broadcast channels. For example, the EPG information recited herein may include at least one of a title of a broadcast content which is broadcasted in a broadcast channel, a replay time, details, information on whether a broadcast content is recorded or not, information on whether recording is programmed or not, a source device which provides a broadcast content or channel information, information of previous/next broadcast contents of a broadcast content, a suggested age of a viewer of a broadcast content, content information related to a broadcast content, producer information of a broadcast content, and casting information of a broadcast content. These information are provided by way of an example only but not by way of a limitation.

Next, referring to view (b) of FIG. 8, the remote control apparatus 100 may receive a third user command of pressing one side of the control surface 15 or removing or stopping to press one side of the control surface 15 after the initial pressing. For example, in the state in which the remote control apparatus 100 receives the first user command of touching one side of the control surface 15, the remote control apparatus 100 may receive a second user command of pressing one side of the continuously touched control surface 15.

In response to the second user command, the remote control apparatus 100 may transmit a signal for changing to the broadcast channel corresponding to one side to the display apparatus 200.

As shown in view (b) of FIG. 8, in response to the received signal, the display apparatus 200 may display the broadcast content 801 which is being provided in the broadcast channel corresponding to one side on screen. For example, in response to receiving a signal indicating that the right side from among both sides of the control surface is pressed, the display apparatus 200 may display the broadcast content 801 which is being provided in the next broadcast channel with respect to the currently reproduced broadcast channel on the entirety of the screen. Alternatively, in response to receiving a signal indicating that the left side from among both sides of the control surface is pressed, the display apparatus 200 may display, on the screen, a broadcast content which is being provided in the previous broadcast channel with respect to the currently reproduced broadcast channel.

FIG. 9 is a view illustrating a process in which the remote control apparatus 100 displays EPG information of a broadcast content provided in the display apparatus 200 according to an exemplary embodiment.

Referring to view (a) of FIG. 9, the remote control apparatus 100 may receive a first user command of touching the center of the control surface 15 while the display apparatus 200 is producing broadcast content 901. In response to the first user command, the remote control apparatus 100 may transmit a signal for displaying EPG information 901-1 to the display apparatus 200.

In response to the received signal, the display apparatus 200 may display the EPG information 901-1 related to the broadcast content 901 which is being reproduced on the screen.

Next, referring to view (b) of FIG. 9, the remote control apparatus 100 may receive a second user command of removing the touch on the center of the control surface 15. In response to the second user command, the remote control apparatus 100 may transmit a signal for stopping displaying the EPG information 901-1 to the display apparatus 200.

In response to the received signal, the display apparatus 200 may remove the EPG information 901-1 which is being displayed from the screen.

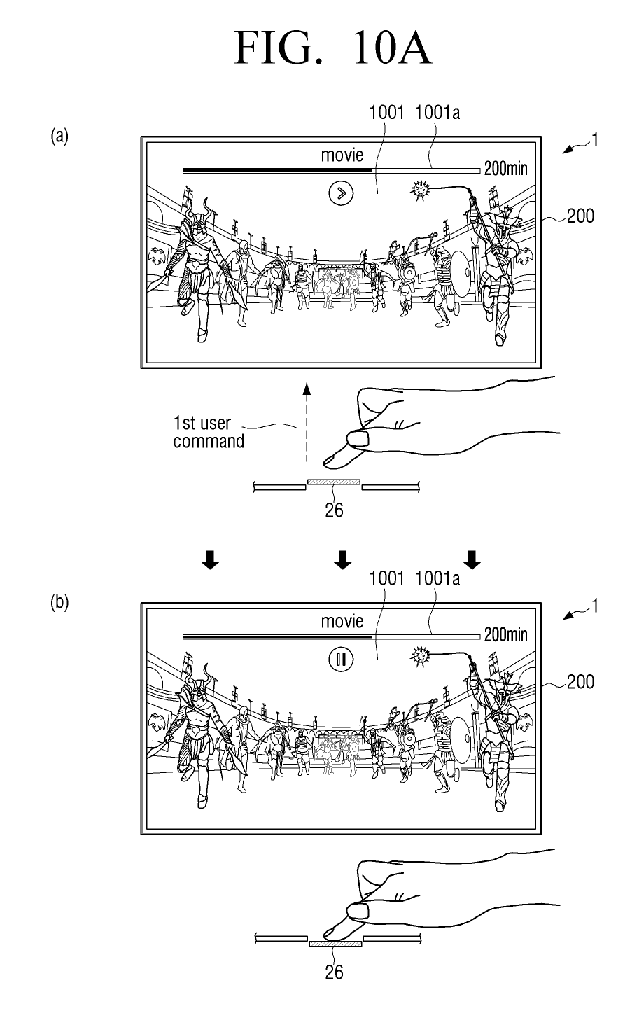

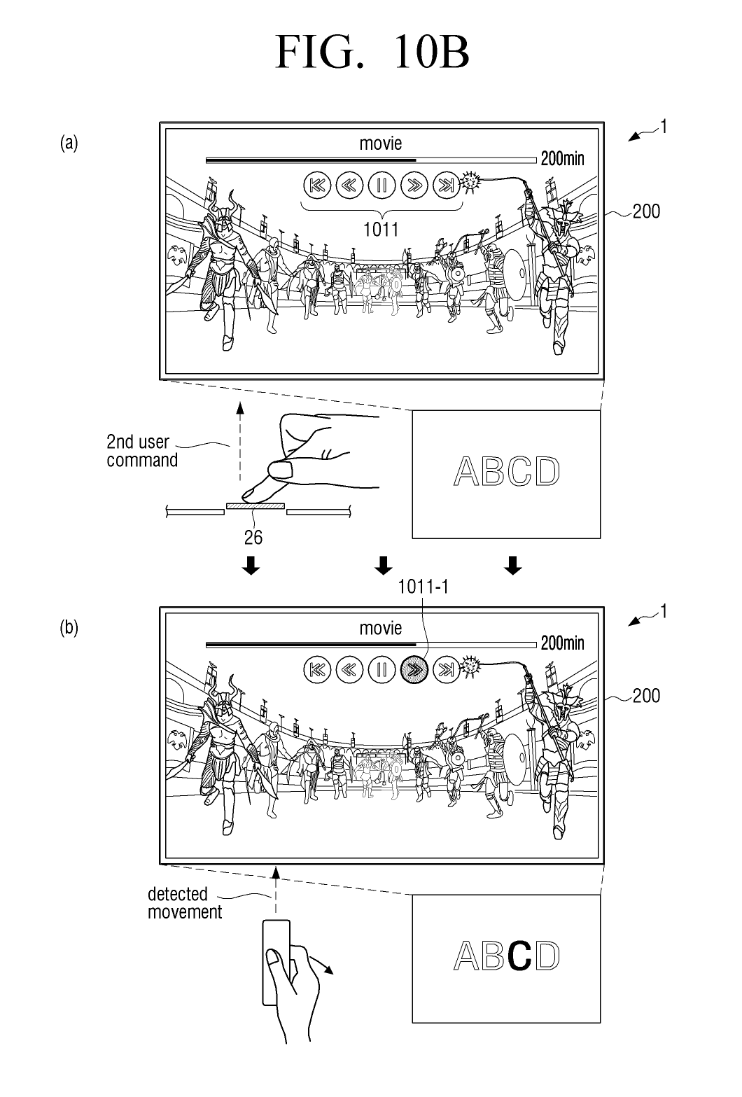

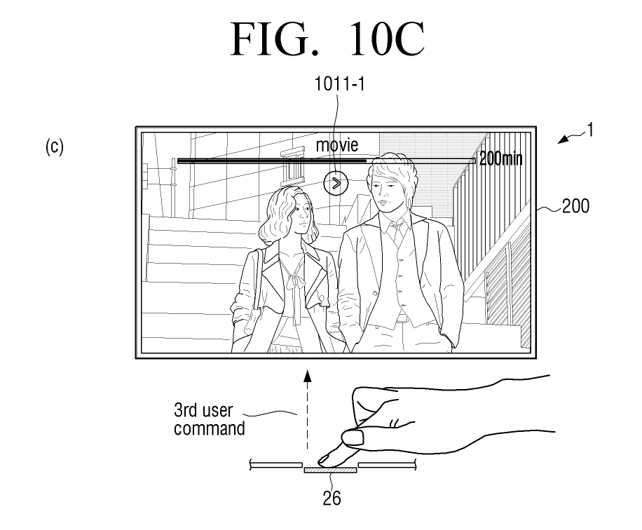

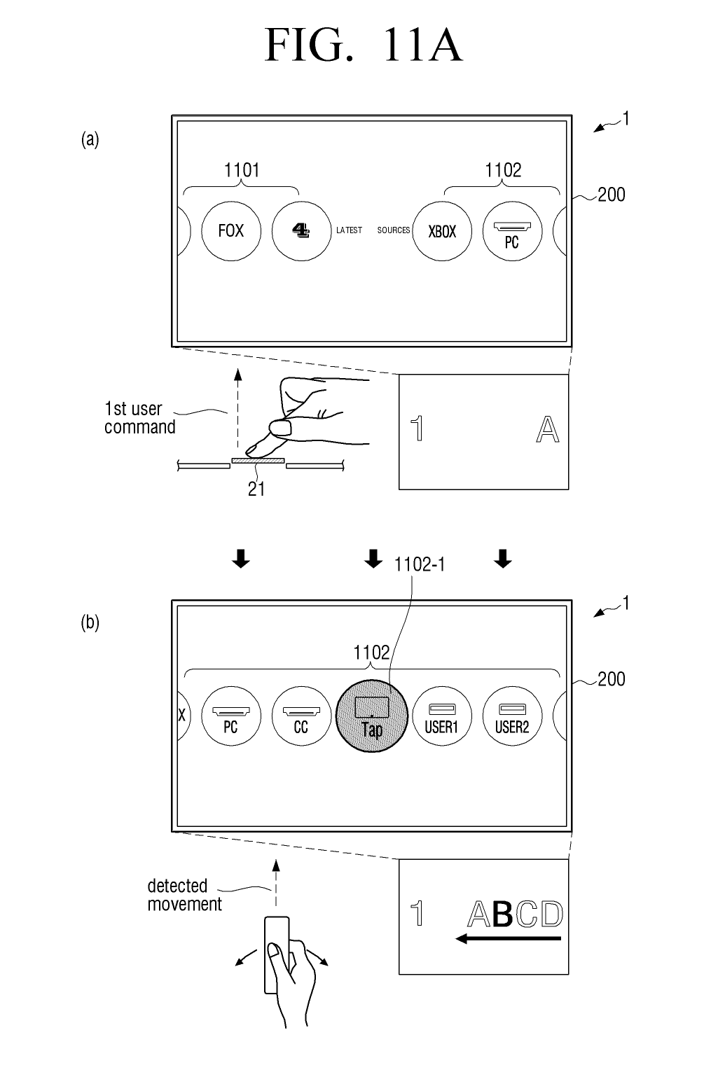

FIGS. 10A to 10C are views illustrating a process in which the remote control apparatus 100 controls content which is provided by the display apparatus 200 according to an exemplary embodiment.

Referring to FIG. 10A, the remote control apparatus 100 may receive a user command of selecting a control surface 26. In this case, the control surface 26 may be a control surface allocated to a content control function.

Referring to view (a) of FIG. 10A, according to an exemplary embodiment, a content 1001 may be reproduced in the display apparatus 200.

In this state, the remote control apparatus 100 may receive a first user command of pressing the control surface 26 In response to the first user command, the remote control apparatus 100 may transmit a signal for controlling the content 1001 to the display apparatus 200, as shown by a bar 1001a.

In this state, the remote control apparatus may receive a second user command or continuously pressing the control surface 26 or by removing or stopping the pressing after the initial pressing as shown in view (b) of FIG. 10A. In response to the received signal, the display apparatus 200 may stop reproducing the content 1001.

Referring to view (a) of FIG. 10B, according to another exemplary embodiment, the remote control apparatus 100 may receive a second user command of touching the control surface 26. In response to the second user command, the remote control apparatus 100 may transmit, to the display apparatus 200, a signal for displaying preview information related to content control on the screen of the display apparatus 200.

In response to the received signal, the display apparatus 200 may display a control menu 1011 including identification information of functions for controlling the reproduced content on the screen as the preview information.

Next, in view (b) of FIG. 10B, the remote control apparatus 100 may detect a movement of the remote control apparatus 100 in one direction. According to the direction of the detected movement, the remote control apparatus 100 may transmit, to a display apparatus 200, a signal for indicating one piece of identification information of the identification information of the functions included in the control menu.

In response to the received signal, the display apparatus 200 may highlight one piece of identification information 1011-1 of the identification information included in the control menu 1011. For example, the highlighted identification information 1011-1 may be identification information of a function of reproducing the content at a fast forward rate. In this case, according to how far the remote control apparatus 100 is moved in one direction, the location of the identification information to be highlighted from among the identification information included in the control menu 1011 may be changed.

Next, in view (c) of FIG. 10C, the remote control apparatus 100 may receive a third user command of pressing the control surface 26 while still touching the control surface 26 or stopping or removing the pressing of the control surface 26 after the initial pressing. Alternatively, the remote control apparatus 100 may receive a third user command of removing the touch on the control surface 26. In response to the third user command, the remote control apparatus 100 may transmit, to a display apparatus 200, a signal for executing a function corresponding to the highlighted identification information 1011-1.

In response to the received signal, the display apparatus 200 may execute the function corresponding to the highlighted identification information 1011-1, and may control the content. For example, the display apparatus 200 may reproduce the content at the fast forward rate.

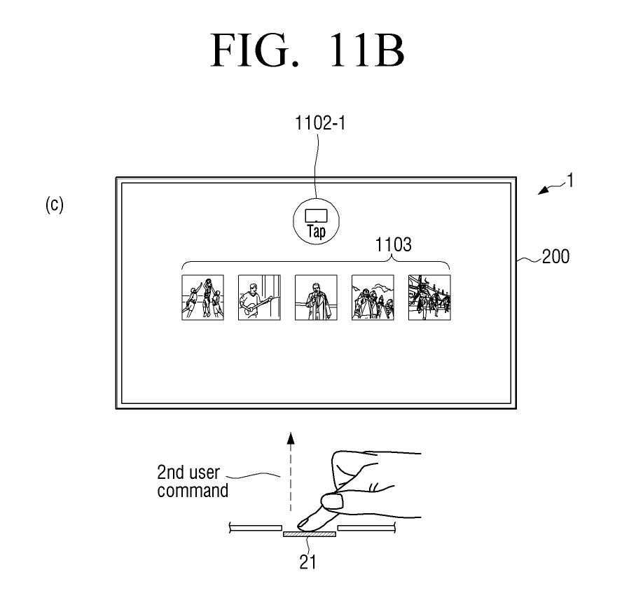

FIGS. 11A and 11B are views illustrating a process in which the remote control apparatus 100 controls the display apparatus 200 to select a content source device according to an exemplary embodiment.

Referring to FIGS. 11A and 11B, the remote control apparatus 100 may receive a user command of selecting a control surface 21. In this case, the control surface 21 may be a control surface allocated functions related to an on/off state of the display apparatus 200, a source device, a broadcast channel execution history, and an application execution history.

Referring to view (a) of FIG. 11A, according to an exemplary embodiment, the remote control apparatus 100 may receive a first user command of touching the control surface 21. In response to the first user command, the remote control apparatus 100 may transmit, to the display apparatus 200, a signal for displaying preview information related to a source device, a content providing history, or an application execution history on the screen of the display apparatus 200.

In response to the received signal, the display apparatus 200 may display a list 1101 including at least one of identification information of applications which have a history of having been executed by the user, or identification information of broadcast channels which have a history of having been executed by the user on one side of the screen as the preview information. In addition, the display apparatus 200 may display a list 1102 of identification information of source devices which can provide contents on the other side of the screen as the preview information.

Next, referring to view (b) of FIG. 11A, the remote control apparatus 100 may detect a movement of the remote control apparatus 100 in one direction. According to the direction of the detected movement, the remote control apparatus 100 may transmit a signal, to the display apparatus 200, for scrolling one 1102 from among the lists displayed on both sides of the screen of the display apparatus 200. For example, the remote control apparatus 100 may detect a leftward movement of the remote control apparatus 100. According to the direction of the detected movement, the remote control apparatus 100 may transmit a signal, to the display apparatus 200, for scrolling the list 1102 displayed on the right side from among the lists displayed on both sides of the display apparatus 200.

In response to the received signal, the display apparatus 200 may scroll the list 1102 from among the lists displayed on both sides. In addition, the display apparatus 200 may highlight one piece of identification information 1102-1 from among the identification information included in the scrolled list 1102. In this case, according to how far the remote control apparatus 100 is moved in one direction, the location of the identification information to be highlighted from among the identification information included in the scrolled list 1102 may be changed.

Next, in view (c) of FIG. 11B, the remote control apparatus 100 may receive a second user command of pressing the control surface 21 while still touching the control surface 21 or removing or stopping the pressing of the control surface 21 after the initial pressing. Alternatively, the remote control apparatus 100 may receive a second user command of removing the touch on the control surface 21. In response to the second user command, the remote control apparatus 100 may transmit, to the display apparatus 200, a signal for displaying a content or a list of contents 1103 included in the source device corresponding to the highlighted identification information 1102-1.

In response to the received signal, the display apparatus 200 may display the content or the list of contents 1103 included in the source device corresponding to the highlighted identification information 1102-1 of the source device on the screen of the display apparatus 200.

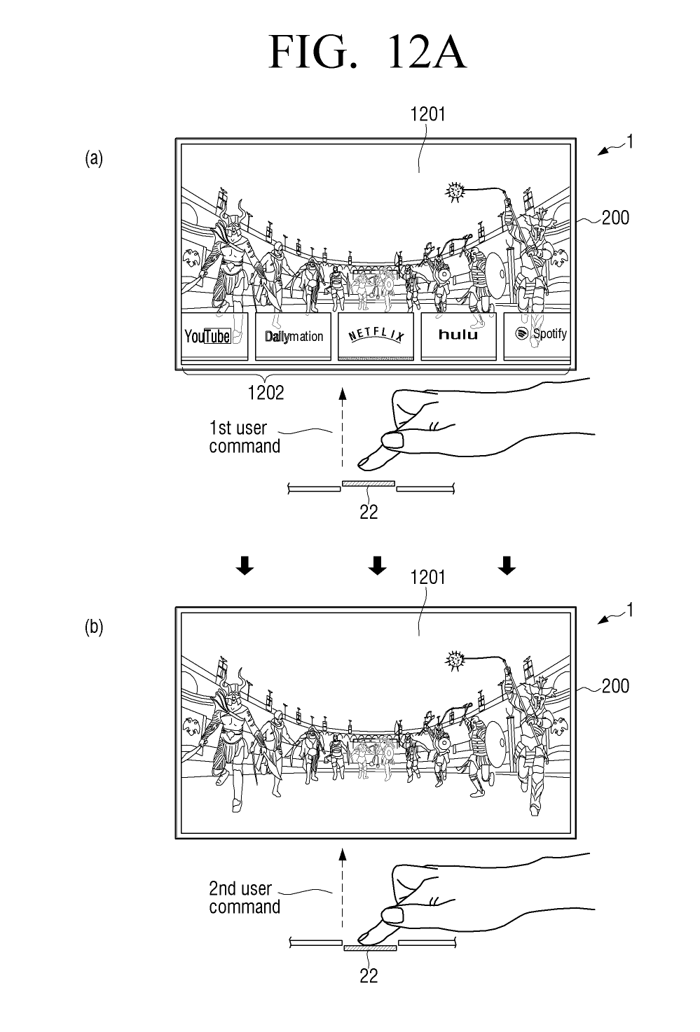

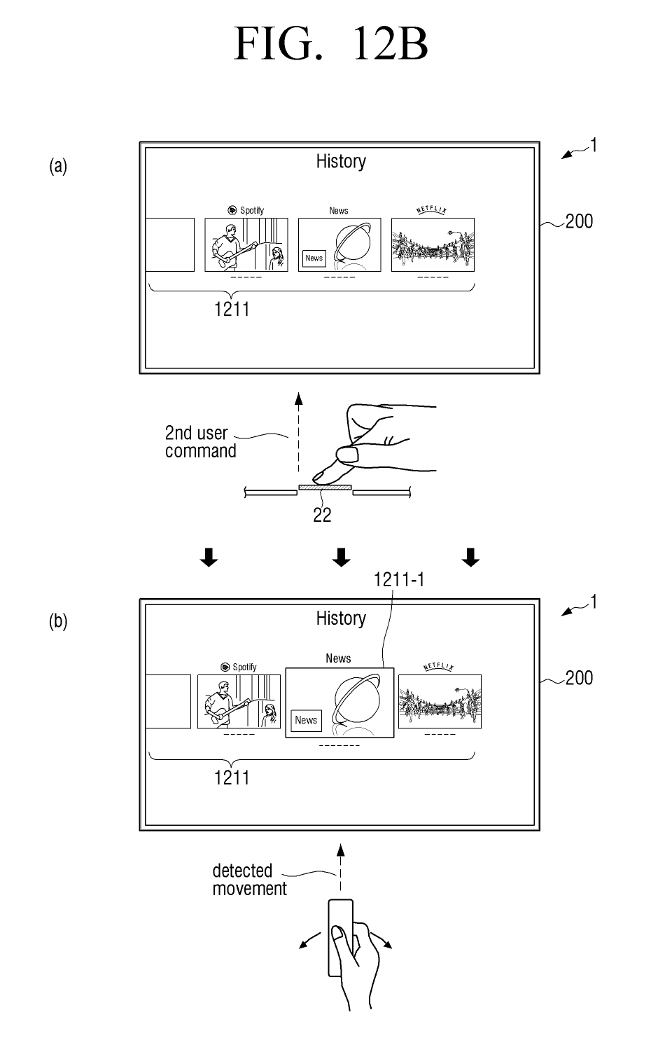

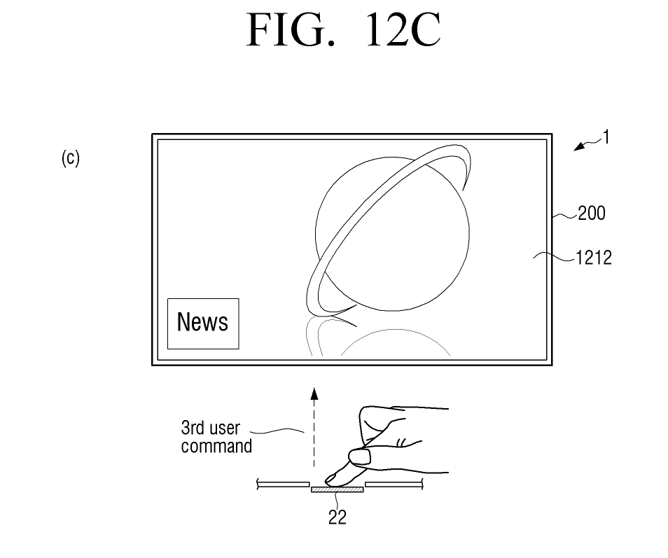

FIGS. 12A to 12C are views illustrating a process in which the remote control apparatus 100 selects content to be reproduced by the display apparatus 200 according to an exemplary embodiment.

Referring to FIG. 12A, the remote control apparatus 100 may receive a user command of selecting a control surface 22. In this case, the control surface 22 may be a control surface allocated a function of changing to a previous screen.

According to an exemplary embodiment, view (a) of FIG. 12A illustrates a state in which identification information 1202 of applications is displayed while content 1201 is being reproduced in the display apparatus 200.

In this state, the remote control apparatus 100 may receive a first user command of pressing the control surface 22 to display the identification information 1202 and in response to a second user command by removing or stopping the pressing after initial pressing as shown in view (b) of FIG. 12A. In response to the first user command and/or the second user command, the remote control apparatus 100 may transmit a signal, to the display apparatus 200, for displaying a previous screen.

In response to the received signal, the display apparatus 200 may display the previous screen. For example, the display apparatus 200 may provide a screen which has been displayed before the identification information 1202 of the applications is displayed. In FIG. 12A, the previous screen may be the screen displaying the content 1201 which is being reproduced.

Referring to view (a) of FIG. 12B, according to another exemplary embodiment, the remote control apparatus 100 may receive a second user command of touching the control surface 22. In response to the second user command, the remote control apparatus 100 may transmit, to the display apparatus 200, a signal for displaying preview information related to a previous display state selection on the screen of the display apparatus 200.

In response to the received signal, the display apparatus 200 may display a list 1211 of applications or previous display screens of broadcast channels on the screen as the preview information. The previous display screens may include still images or moving images of contents which have been executed through applications or broadcast channels.

Next, in view (b) of FIG. 12B, the remote control apparatus 100 may detect a movement of the remote control apparatus 100 in one direction. According to the direction of the detected movement, the remote control apparatus 100 may transmit a signal, to the display apparatus 200, for indicating one piece of identification information 1211-1 from among the identification information of the previous display screens included in the list 1211.

In response to the received signal, the display apparatus 200 may highlight one piece of identification information 1211-1 from among the identification information included in the list 1211. In this case, according to how far the remote control apparatus 100 is moved in one direction, the location of the identification information to be highlighted from among the identification information of the contents included in the list 1211 may be changed.

Next, in view (c) of FIG. 12C, the remote control apparatus 100 may receive a third user command of pressing the control surface 22 while still touching the control surface 22 or by stopping or removing the pressing of the control surface 22 after the initial pressing. In response to the third user command, the remote control apparatus 100 may transmit a signal for displaying a previous display screen corresponding to the highlighted identification information 1211-1 to the display apparatus 200.

In response to the received signal, the display apparatus 200 may execute an application or a broadcast channel related to the previous display screen corresponding to the highlighted identification information 1211-1 of the source device, and reproduce content 1212 displayed on the previous display screen through the executed application and display the content 1212.

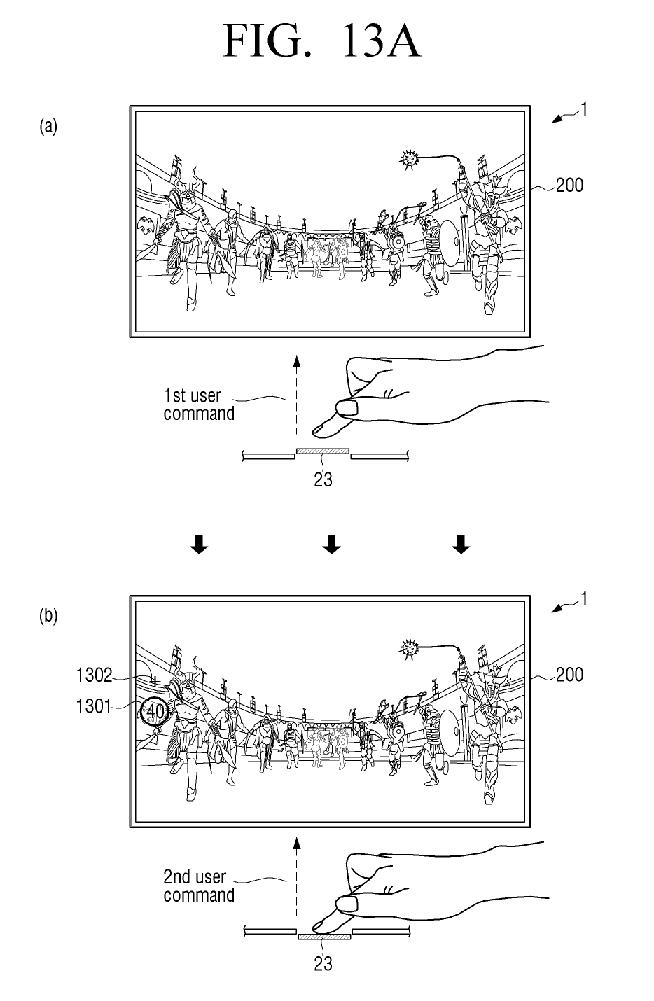

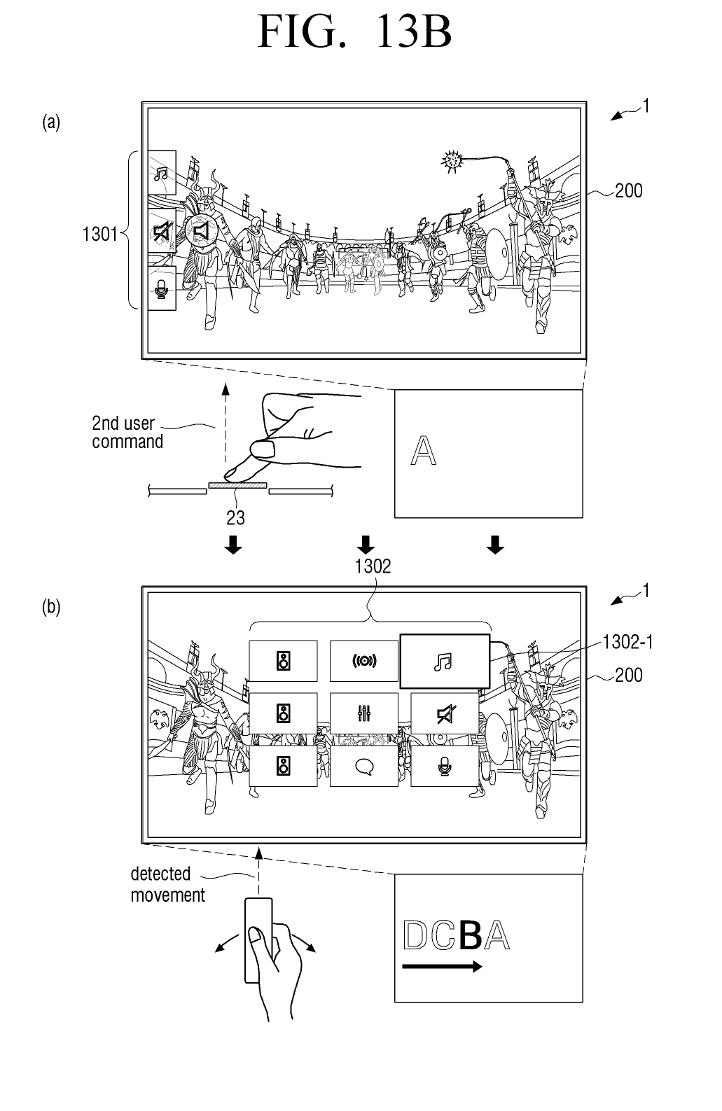

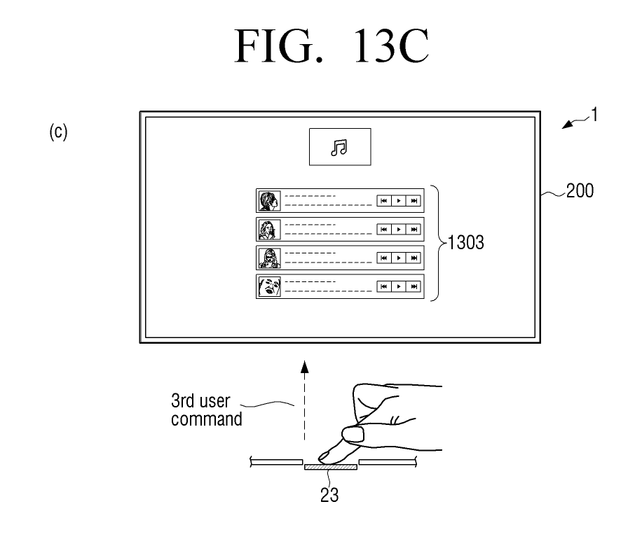

FIGS. 13A to 13C are views illustrating a process in which the remote control apparatus 100 controls volume of the display apparatus 200 according to an exemplary embodiment.

Referring to FIG. 13A, the remote control apparatus 100 may receive a user command of selecting a control surface 23. In this case, the control surface 23 may be a control surface allocated a volume control function.

Referring to view (a) of FIG. 13A, according to an exemplary embodiment, content may be reproduced in the display apparatus 200.

In this state, the remote control apparatus 100 may receive a first user command of pressing the control surface 23 or a second user command by stopping or removing the pressing after the initial pressing as shown in view (b) of FIG. 13A. In response to the first user command and/or the second user command, the remote control apparatus 100 may transmit a signal, to the display apparatus 200, for changing the volume.

In response to the received signal, the display apparatus 200 may display a screen including volume information. For example, the display apparatus 200 may display current volume information 1301 and identification information 1302 related to a volume increase.

Referring to view (a) of FIG. 13B, according to another exemplary embodiment, the remote control apparatus 100 may receive a second user command of touching the control surface 23. In response to the second user command, the remote control apparatus 100 may transmit, to the display apparatus 200, a signal for displaying preview information related to the volume control function on the screen of the display apparatus 200.

In response to the received signal, the display apparatus 200 may display a control menu 1301 including identification information of main functions for controlling the volume on the screen as the preview information.

Next, in view (b) of FIG. 13B, the remote control apparatus 100 may detect a movement of the remote control apparatus 100 in one direction. According to the direction of the detected movement, the remote control apparatus 100 may transmit a signal for further displaying identification information of other functions for controlling the volume on the screen of the display apparatus 200 to the display apparatus 200.

In response to the received signal, the display apparatus 200 may display a control menu 1302 including the identification information of all functions for controlling the volume while scrolling in one direction, and may highlight one piece of identification information 1302-1 from among the identification information. For example, the plurality of functions may include at least one of changing to a mute mode, providing an audio list, searching an audio, providing a speaker list, providing an audio service, a speaker arrangement list, a volume increase, and a volume decrease. These functions are provided by way of an example only and not by way of a limitation.

For example, the highlighted identification information 1302-1 may be identification information of a function for displaying an audio list which can be provided in the display apparatus 200. In this case, according to how far or in which direction the remote control apparatus 100 is moved, the location of the identification information to be highlighted from among the identification information of the plurality of functions may be changed.

Next, in view (c) of FIG. 13C, the remote control apparatus 100 may receive a third user command of pressing the control surface 23 while still touching the control surface 23 or by stopping or removing the pressing after the initial pressing. In response to the third user command, the remote control apparatus 100 may transmit a signal for executing the function corresponding to the highlighted identification information 1302-1 to the display apparatus 200.

In response to the received signal, the display apparatus 200 may execute the function corresponding to the highlighted identification information 1302-1. For example, the display apparatus 200 may display a list of audios 1303 which can be reproduced by the display apparatus 200.

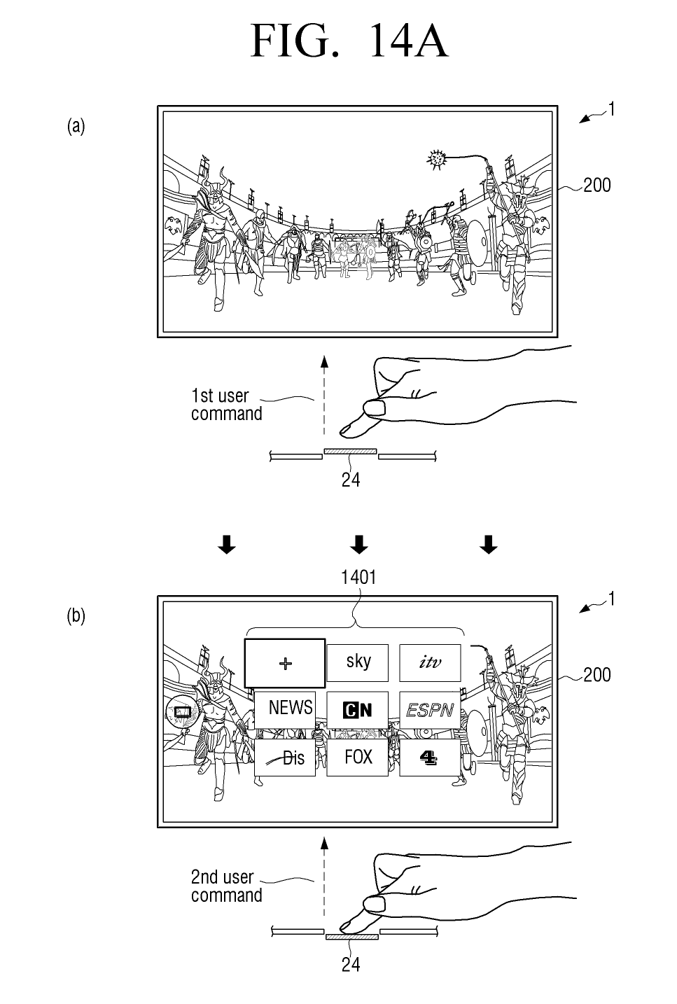

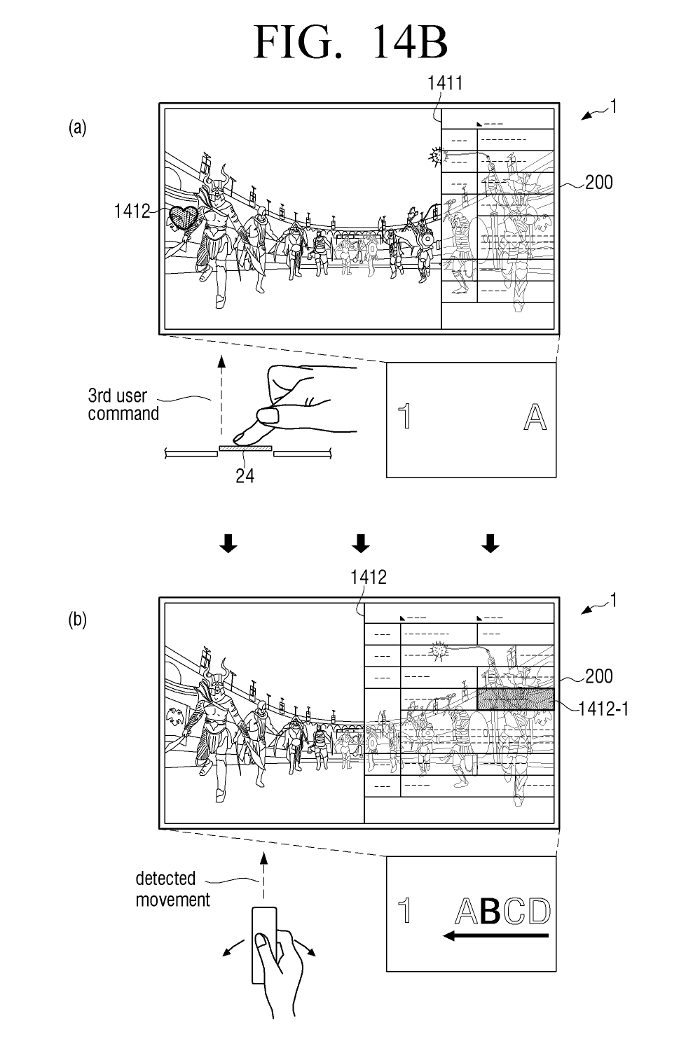

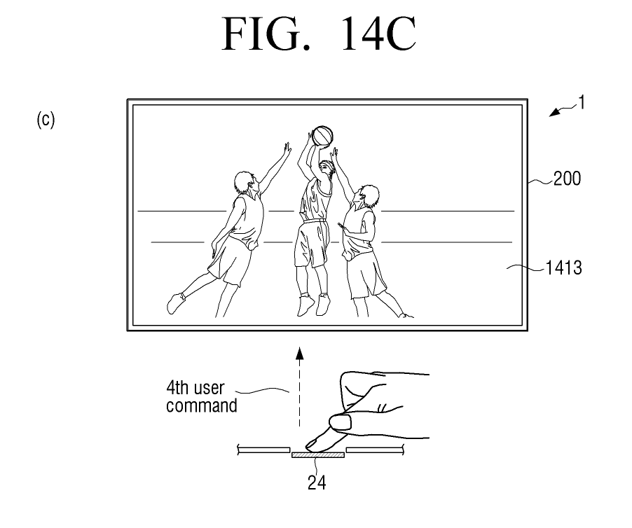

FIGS. 14A to 14C are views illustrating a process in which the remote control apparatus 100 selects a broadcast channel of the display apparatus 200 according to an exemplary embodiment.

Referring to FIG. 14A, the remote control apparatus 100 may receive a user command of selecting a control surface 24 of the plurality of control surfaces. In this case, the control surface 24 may be a control surface allocated to a broadcast channel selection function.

Referring to view (a) of FIG. 14A, according to an exemplary embodiment, content may be reproduced in the display apparatus 200.

In this state, the remote control apparatus 100 may receive a first user command of pressing the control surface 24 or a second user command of removing or stopping the pressing of the control surface 24 after the initial pressing as shown in view (b) of FIG. 14A. In response to the first user command and/or the second user command, the remote control apparatus 100 may transmit a signal for selecting a broadcast channel to the display apparatus 200.

In response to the received signal, the display apparatus 200 may display a list 1401 including identification information of broadcast channels.

Referring to view (a) of FIG. 14B, according to another exemplary embodiment, the remote control apparatus 100 may receive a third user command of touching the control surface 24. In response to the third user command, the remote control apparatus 100 may transmit, to the display apparatus 200, a signal for displaying preview information related to a broadcast channel selection function on the screen of the display apparatus 200.

In response to the received signal, the display apparatus 200 may display EPG information 1411 of broadcast channels in a predetermined time zone (for example, one or two hours) on one side of the screen as the preview information. In this case, the display apparatus 200 may display a user interface providing a user's preference channel on another side of the screen as the preview information.

Next, in view (b) of FIG. 14B, the remote control apparatus 100 may detect a movement of the remote control apparatus 100 in one direction. According to the direction of the detected movement, the remote control apparatus 100 may transmit a signal for displaying additional EPG information on the screen of the display apparatus 200 to the display apparatus 200.

In response to the received signal, the display apparatus 200 may display EPG information 1412 in more time zones than that of the preview information while scrolling in one direction, and may highlight one piece of identification information 1412-1 from among the identification information of broadcast contents included in the EPG information 1412. In this case, according to how far or in which direction the remote control apparatus 100 is moved, the location of the identification information to be highlighted from among the identification information of the broadcast contents may be changed.

Next, in view (c) of FIG. 14C, the remote control apparatus 100 may receive a fourth user command of pressing the control surface 24 while still touching the control surface 24 or by stopping or removing the pressing after the initial pressing. In response to the fourth user command, the remote control apparatus 100 may transmit, to the display apparatus 200, a signal for reproducing or booking broadcast content 1413 corresponding to the highlighted identification information 1412-1.

In response to the received signal, the display apparatus 200 may change to a broadcast channel providing the broadcast content 1413 corresponding to the highlighted identification information 1412-1, and reproduce the broadcast content 1413 received from the changed broadcast channel. Alternatively, the display apparatus 200 may book the broadcast content 1413 corresponding to the highlighted identification information 1412-1. In this case, when scheduled time arrives, the display apparatus 200 may automatically change to the broadcast channel providing the broadcast content 1413 and reproduce the booked broadcast content 1413. Alternatively, the display apparatus 200 may not change to the broadcast channel providing the broadcast content 1413 and may record the booked broadcast content 1413.

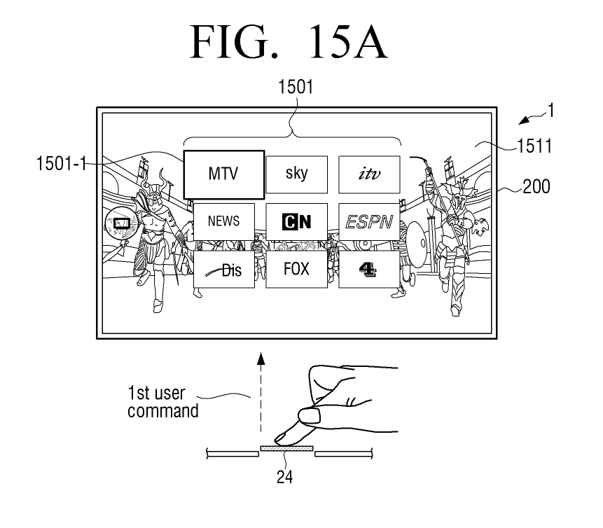

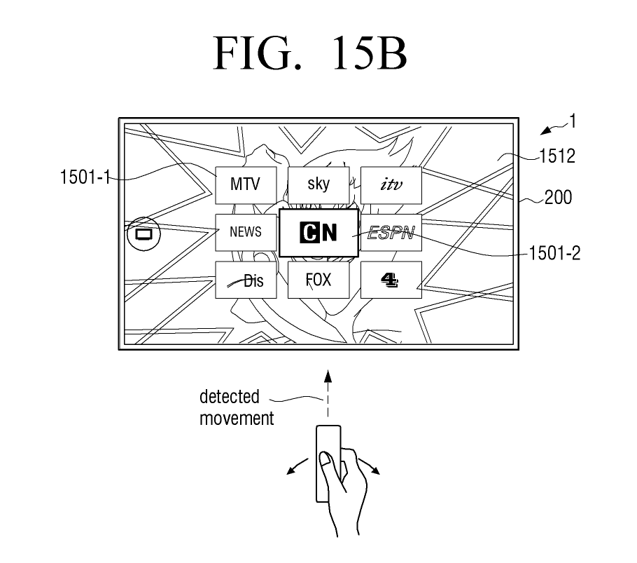

FIGS. 15A and 15B are views illustrating a process in which the remote control apparatus 100 selects a broadcast channel of the display apparatus 200 according to another exemplary embodiment.

In FIG. 15A, the remote control apparatus 100 may receive a user command of selecting the control surface 24. In this case, the control surface 24 may be a control surface allocated a broadcast channel selection function.

Referring to FIG. 15A, according to an exemplary embodiment, the remote control apparatus 100 may receive a first user command of touching the control surface 24. In response to the first user command, the remote control apparatus 100 may transmit a signal for displaying preview information related to a broadcast content providing function on the screen of the display apparatus 200 to the display apparatus 200.

In response to the received signal, the display apparatus 200 may display a broadcast channel list 1501 including identification information of broadcast channels as the preview information. In this case, the display apparatus 200 may highlight one piece of identification information 1501-1 from among the identification information of the broadcast channels. The display apparatus 200 may provide a broadcast content 1511 which is being provided by the broadcast channel corresponding to the highlighted identification information 1501-1 through the screen as a background content of the broadcast channel list 1501.

Next, in FIG. 15B, the remote control apparatus 100 may detect a movement of the remote control apparatus 100 in one direction. According to the direction of the detected movement, the remote control apparatus 100 may transmit a signal for moving the location of the highlight on the screen to a different location to the display apparatus 200.

In response to the received signal, the display apparatus 200 may change the location of the highlight indicating the identification information 1501-1 of one broadcast channel included in the broadcast channel list 1501 to indicate identification information 1501-2 of another broadcast channel. In this case, the display apparatus 200 may provide a broadcast content 1512 which is being provided by the broadcast channel corresponding to the newly highlighted identification information 1501-2 through the screen as the background content of the broadcast channel list.

As described above, the display apparatus 200 may provide the broadcast content which is being provided by the highlighted broadcast channel through the screen as the background content, while the identification information of the broadcast channel is being highlighted.

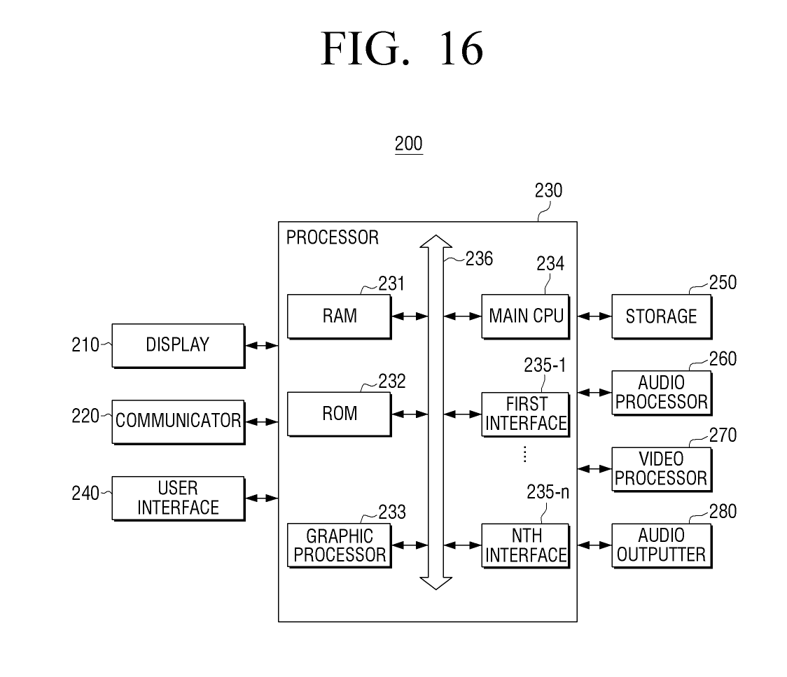

FIG. 16 is a block diagram showing a configuration of the display apparatus 200 according to another exemplary embodiment.

As shown in FIG. 16, the display apparatus 200 according to another exemplary embodiment may include a display 210, a communicator 220, a processor 230, a user interface 240, a storage 250, an audio processor 260, a video processor 270, and an audio outputter 280. Hereinafter, a redundant explanation of the same elements as in FIG. 3 will be omitted.

The user interface 240 is configured to detect a user interaction for controlling the overall operations of the display apparatus 200. In particular, the user interface 240 may include various interaction detection devices such as a camera (not shown), a microphone (not shown), a remote control signal receiver (not shown), or the like.

The storage 250 is configured to store various modules for driving the display apparatus 200. The storage 250 may include one or more memories.

Specifically, the storage 250 may store a base module for processing signals transmitted from hardware included in the display apparatus 200, a storage module for managing a data DB or registry, a security module, a communication module, or the like. In particular, the storage 250 may store a module which divides a display screen into a plurality of display areas and controls the areas individually.

The audio processor 260 is an element for processing audio data.

The video processor 270 is an element for performing various image processing operations such as decoding, scaling, noise filtering, frame rate conversion, resolution conversion, or the like with respect to an inputted image.

The audio outputter 280 is an element for outputting an audio such as a speaker.

The processor 230 controls the overall operations of the display apparatus 200 using various modules stored in the storage 250.

As shown in FIG. 16, the processor 230 includes a Random Access Memory (RAM) 231, a Read Only Memory (ROM) 232, a graphic processor 233, a main CPU 234, first to nth interfaces 235-1 to 235-n, and a bus 236. In this case, the RAM 231, the ROM 232, the graphic processor 233, the main CPU 234, and the first to nth interfaces 235-1 to 235-n may be connected with one another via the bus 236.

The ROM 232 stores a set of commands for booting a system. The main CPU 234 copies various application programs stored in the storage 250 into the RAM 231, and performs various operations by executing the application programs copied into the RAM 231.

The graphic processor 233 generates a screen including various objects such as an icon, an image, a text, and the like, using a calculator (not shown) and a renderer (not shown). The calculator calculates attribute values of the objects to be displayed such as coordinate values, shape, size, color, and the like of the objects according to the layout of the screen. The renderer generates the screen of various layouts including the objects based on the attribute values calculated by the calculator.

The main CPU 234 accesses the storage 250 and performs booting using an O/S stored in the storage 250. In addition, the main CPU 234 performs various operations using various programs, contents, and data stored in the storage 250.

The first to nth interfaces 235-1 to 235-n are connected with the above-described various elements. One of the interfaces may be a network interface which is connected with an external device through a network.

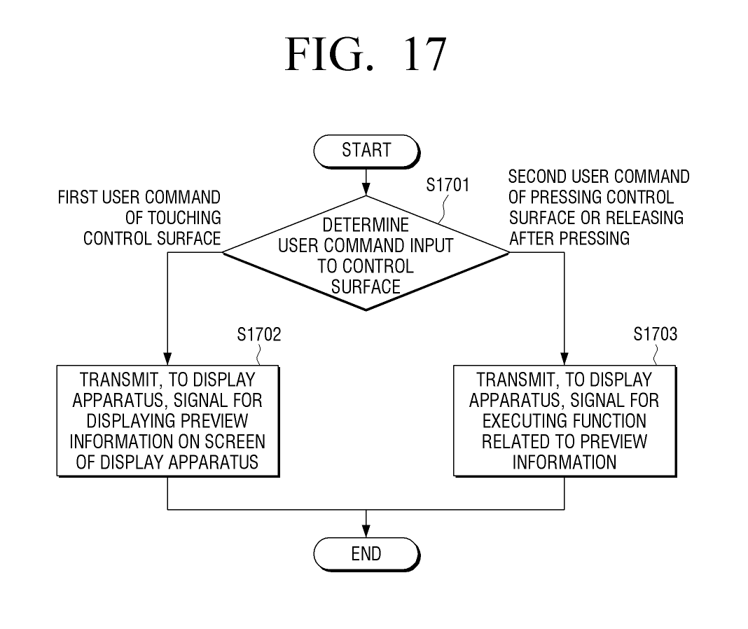

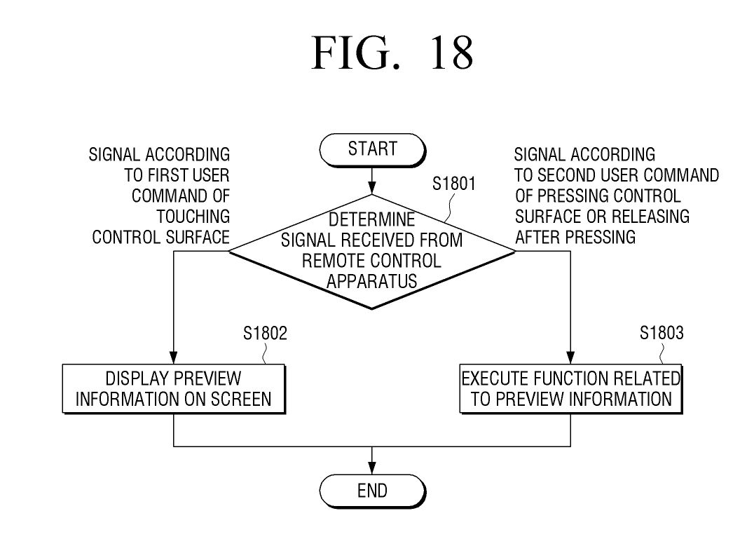

FIG. 17 is a flowchart illustrating a method of controlling the display apparatus 200 by the remote control apparatus 100 according to an exemplary embodiment.

First, the remote control apparatus 100 may determine a user command which is input to a control surface in operation (S1701).

In response to the input user command being a first user command of touching the control surface as a result of the determining, the remote control apparatus 100 may transmit, to the display apparatus 200, a signal for displaying preview information on the screen of the display apparatus 200 in operation (S1702). On the other hand, in response to the input user command being a second user command of pressing or stopping or releasing the pressing after the initial pressing, the remote control apparatus 100 may transmit, to the display apparatus 200, a signal for executing a function related to the preview information in operation (S1703). The function related to the preview information may include at least one of a function of displaying visual information related to the preview information on the screen of the display apparatus 200, a function of outputting auditory information related to the preview information, and a function of transmitting data related to the preview information to an external device.

In response to the control surface being a control surface allocated to a function related to an application, the preview information may be an application history list including identification information of applications which have a history of having been executed by the user through the display apparatus 200, and the function related to the preview information may be a function of displaying an application list including identification information of applications which are executable through the display apparatus.

In response to the control surface being a control surface allocated a function related to a broadcast channel, the preview information may be a broadcast channel history list including identification information of broadcast channels which have a history of having been viewed by the user through the display apparatus 200, and the function related to the preview information may be a function of displaying a broadcast channel list including identification information of broadcast channels which are able to provide broadcast contents through the display apparatus 200.

In addition, in response to the control surface being a control surface allocated to a function related to content, the preview information may be a control menu including identification information of functions for controlling content which is being provided through the display apparatus 200, and the function related to the preview information may be a function corresponding to identification information which is selected according to the second user command from among the identification information of the functions included in the control menu.

In addition, in response to the control surface being a control surface allocated to a function related to a source device, the preview information may be a source list including identification information of source devices which are able to provide contents through the display apparatus 200, and the function related to the preview information may be a function of displaying a content or a list of contents included in a source device corresponding to identification information which is selected according to the second user command from among the identification information included in the source list.

In addition, in response to the control surface being a control surface allocated to a function related to broadcast channel zapping, the preview information may be EPG information of a previous or next broadcast channel of a current broadcast channel which is being provided through the display apparatus 200, and a part of a broadcast content which is being provided in the previous or next broadcast channel, and the function related to the preview information may be a function of displaying broadcast content which is being reproduced in the previous or next broadcast channel.

FIG. 18 is a flowchart illustrating a method of executing the display apparatus 200 by the remote control apparatus 100 according to an exemplary embodiment.

First, the display apparatus 200 may determine a signal which is received from the remote control apparatus 100 in operation (S1801).

In response to the received signal being a signal according to a first user command of touching a control surface as a result of the determining, the display apparatus 200 may display preview information on the screen in operation (S1802). On the other hand, in response to the received signal being a signal according to a second user command of pressing the control surface or by releasing or stopping the initial pressing, the display apparatus 200 may perform a function related to the preview information in operation (S1803).

The function related to the preview information may include at least one of a function of displaying visual information related to the preview information on the screen of the display apparatus 200, a function of outputting auditory information related to the preview information, and a function of transmitting data related to the preview information to an external device.

In response to the control surface being a control surface allocated to a function related to an application, the preview information may be an application history list including identification information of applications which have a history of having been executed by the user through the display apparatus 200 i.e., previously executed applications, and the function related to the preview information may be a function of displaying an application list including identification information of applications which are executable through the display apparatus.

In response to the control surface being a control surface allocated to a function related to a broadcast channel, the preview information may be a broadcast channel history list including identification information of broadcast channels which have a history of having been viewed by the user through the display apparatus 200 i.e., previously viewed channels, and the function related to the preview information may be a function of displaying a broadcast channel list including identification information of broadcast channels which are able to provide broadcast contents through the display apparatus 200.

In addition, in response to the control surface being a control surface allocated to a function related to content, the preview information may be a control menu including identification information of functions for controlling content which is being provided through the display apparatus 200, and the function related to the preview information may be a function corresponding to identification information which is selected according to the second user command from among the identification information of the functions included in the control menu.

In addition, in response to the control surface being a control surface allocated to a function related to a source device, the preview information may be a source list including identification information of source devices which are able to provide contents through the display apparatus 200, and the function related to the preview information may be a function of displaying a content or a list of contents included in a source device corresponding to identification information which is selected according to the second user command from among the identification information included in the source list.

In addition, in response to the control surface being a control surface allocated a function related to broadcast channel zapping, the preview information may be EPG information of a previous or next broadcast channel of a current broadcast channel which is being provided through the display apparatus 200, and a part of a broadcast content which is being provided in the previous or next broadcast channel, and the function related to the preview information may be a function of displaying a broadcast content which is being reproduced in the previous or next broadcast channel.

The methods for executing the remote control apparatus and the display apparatus according to the above-described various exemplary embodiments may be implemented as a program and may be stored in various recording media. That is, a computer program which is processed by various processors and can execute the above-described various control methods may be stored on a recording medium and used.

For example, a non-transitory computer readable medium storing a program, which includes: receiving a first user command of touching a control surface or a second user command of pressing the control surface or removing the press after pressing; and, in response to the first user command being inputted, transmitting, to the display apparatus, a signal for displaying preview information on a screen of the display apparatus, and, in response to the second user command being inputted, transmitting a signal for executing a function related to the preview information to the display apparatus, may be provided.

Alternatively, a non-transitory computer readable medium storing a program, which includes: communicating with a remote control apparatus provided with a control surface on which a touch or a press is possible; and, in response to a signal according to a first user command of touching the control surface being received from the remote control apparatus, displaying preview information on a screen, and, in response to a signal according to a second user command of pressing the control surface or removing the press after pressing being received from the remote control apparatus, executing a function related to the preview information, may be provided.

The non-transitory computer readable medium refers to a medium that stores data semi-permanently rather than storing data for a very short time, such as a register, a cache, a memory or etc., and is readable by an apparatus. Specifically, the above-described various applications or programs may be stored in the non-transitory computer readable medium such as a compact disc (CD), a digital versatile disk (DVD), a hard disk, a Blu-ray disk, a universal serial bus (USB), a memory card, a ROM or etc., and may be provided.

The foregoing exemplary embodiments are merely exemplary and are not to be construed as limiting. The exemplary embodiment can readily be applied to other types of apparatuses. Also, the description of exemplary embodiments is intended to be illustrative, and not to limit the scope of the claims, and many alternatives, modifications, and variations will be apparent to those skilled in the art and are within the scope of the inventive concept.

What is claimed is:

1. A remote control apparatus which controls a display apparatus, the remote control apparatus comprising:
a communicator configured to communicate with the display apparatus;
a user interface configured to receive a user command; and
a processor configured to control the communicator to transmit, to the display apparatus, a signal corresponding to the received user command,
wherein, in response to the user command being a first user command in which a control surface of the user interface is touched, the transmitted signal requests displaying preview information on a screen of the display apparatus, and
wherein, in response to the user command being a second user command in which the control surface is at least pressed, the transmitted signal requests an execution of a preview information related function.

2. The remote control apparatus of claim 1, wherein the preview information related function comprises at least one of: a first function of displaying visual information related to the preview information, a second function of outputting auditory information related to the preview information, and a third function of transmitting data related to the preview information to an external device.

3. The remote control apparatus of claim 1, wherein, in response to the control surface being allocated to an application function, the preview information comprises an application history list with identification information of previously executed applications, and the preview information related function comprises displaying an application list comprising identification information of applications which are executable by the display apparatus and the previously executed applications.

4. The remote control apparatus of claim 1, wherein, in response to the control surface being allocated to a broadcast channel function, the preview information comprises a broadcast channel history list with identification information of previously viewed broadcast channels, and the preview information related function comprises displaying a broadcast channel list comprising identification information of broadcast channels which are able to provide broadcast contents through the display apparatus and the previously viewed broadcast channels.

5. The remote control apparatus of claim 1, wherein, in response to the control surface being allocated to a content related function, the preview information comprises a control menu with identification information of controlling content functions provided by the display apparatus, and the preview information related function corresponds to identification information selected according to the second user command from among the identification information of the controlling content functions included in the control menu.

6. The remote control apparatus of claim 1, wherein, in response to the control surface being allocated to a source device related function, the preview information comprises a source list with identification information of source devices which are able to provide contents through the display apparatus, and the preview information related function comprises displaying one of content and a list of contents provided by a source device corresponding to identification information selected according to the second user command from among the identification information of the source devices included in the source list.

7. The remote control apparatus of claim 1, wherein, in response to the control surface being allocated to a broadcast channel zapping related function, the preview information comprises EPG information of at least one of a portion of broadcast content provided by at least one previous broadcast channel and a portion of broadcast content provided by at least one next broadcast channel with respect to a currently broadcast channel, and the preview information related function comprises displaying an entire broadcast content being reproduced by one of the previous broadcast channel and the next broadcast channel.

8. The remote control apparatus of claim 1, further comprising:
a detector configured to detect a moving direction of the remote control apparatus, and
wherein the processor is configured to control the communicator to transmit, to the display apparatus, a signal for changing an emphasized location on the screen of the display apparatus to a different location based on the detected moving direction.

9. The remote control apparatus of claim 1, wherein, during the first user command, the user interface is configured to receive the second user command of continuously pressing the touched control surface.

10. A display apparatus which is controlled by a remote control apparatus, the display apparatus comprising:
a display configured to display a screen;
a communicator configured to communicate with the remote control apparatus which is provided with a control surface; and
a processor configured to, control the display apparatus based on a signal provided by the communicator,
wherein, in response to the signal corresponding to a first user command indicating that the control surface is being touched, the display displays preview information on the screen, and
wherein, in response to the signal corresponding to a second user command indicating that the control surface is at least pressed, the processor executes a preview information related function.

11. The display apparatus of claim 10, wherein the preview information related function comprises at least one of a first function of displaying visual information related to the preview information on the screen of the display apparatus, a second function of outputting auditory information related to the preview information, and a third function of transmitting data related to the preview information to an external device.

12. The display apparatus of claim 10, wherein, in response to the control surface being allocated to an application related function, the preview information comprises an application history list with identification information of previously executed applications, and the preview information related function comprises displaying an application list comprising identification information of applications which are executable by the display apparatus and the previously executed application.

13. The display apparatus of claim 10, wherein, in response to the control surface being allocated to a broadcast channel function, the preview information comprises a broadcast channel history list with identification information of previously viewed broadcast channels, and the preview information related function comprises displaying a broadcast channel list with identification information of broadcast channels which provide broadcast contents through the display apparatus and the previously viewed broadcast channels.

14. The display apparatus of claim 10, wherein, in response to the control surface being allocated to a content related function, the preview information comprises a control menu with identification information of functions for controlling content provided through the display apparatus, and the preview information related function corresponds to identification information which is selected based on the second user command from among the identification information of the functions included in the control menu.

15. The display apparatus of claim 10, wherein, in response to the control surface being allocated to a source device related function, the preview information comprises a source list with identification information of source devices which provide contents through the display apparatus, and the preview information related function comprises displaying content or a list of contents included in a source device corresponding to identification information which is selected according to the second user command from among the identification information included in the source list.

16. The display apparatus of claim 10, wherein, in response to the control surface being allocated to a broadcast channel zapping function, the preview information comprises EPG information of at least one of a portion of at least one previous broadcast channel and a portion of at least one next broadcast channel with respect to a currently broadcast channel, and the preview information related function comprises displaying an entire broadcast content which is being reproduced by one of the previous broadcast channel and the next broadcast channel.

17. A method for controlling a display apparatus by a remote control apparatus, the method comprising:
receiving one of: a first user command of touching a control surface and a second user command of pressing the control surface or release pressing the control surface; and
in response to receiving the first user command, transmitting, to the display apparatus, a signal for displaying preview information, and
in response to receiving the second user command, transmitting, to the display apparatus, a signal for executing a preview information related function.

18. The method of claim 17, wherein the preview information related function comprises at least one of: a first function of displaying visual information related to the preview information on the screen of the display apparatus, a second function of outputting auditory information related to the preview information, and a third function of transmitting data related to the preview information to an external device.
